(19) United States
(12) Patent Application Publication
(10) Pub. No.: US 2024/0292869 A1
(43) Pub. Date: Sep. 5, 2024

(54) VEGAN FOOD PRODUCT SUCH AS A VEGAN EGG

(71) Applicant: Migros Industrie AG, Zürich (CH)

(72) Inventors: Lucie Elizabeth KENDALL, Wädenswil (CH); Elio RICCI, Estavayer-Le-Lac (CH); Markus MÜLLER, Reichshof (DE)

(73) Assignee: Migros Industrie AG, Zürich (CH)

(21) Appl. No.: 18/689,657

(22) PCT Filed: Sep. 20, 2022
(86) PCT No.: PCT/EP2022/076050

§ 371 Date: Mar. 6, 2024

(30) Foreign Application Priority Data
Sep. 20, 2021 (EP) 21197719.4

(51) Int. Cl. A23L 15/00; A23L 29/256; A23L 33/21

(52) U.S. Cl. CPC A23L 15/35; A23L 29/256; A23L 33/21

(57) ABSTRACT

A vegan food product, in particular a vegan hard-boiled egg, has at least one outer layer, and at least one inner core. The inner core is surrounded by the outer layer. The inner core has at least one vegan fibre and the outer layer has at least one vegan fibre. The vegan fibre of the inner core has a water-binding capacity of 40 g/g or less, preferably of 30 g/g or less, particularly preferably 15 g/g or less. The vegan fibre of the outer layer has a water-binding capacity of 40 g/g or less, preferably of 30 g/g or less, particularly preferably of 25 g/g or less.

### TECHNICAL FIELD

The present invention relates to a vegan food product according to claim 1, to a method of producing a vegan food product according to claim 8, and to the use of a vegan fibre for producing a vegan food product according to claim 15.

### PRIOR ART

Vegan food products replacing food products of animal origin are very popular nowadays due to various reasons including personal choices or health aspects. In particular, vegan eggs became attractive in view of a species-appropriate animal husbandry or a healthy diet being low in cholesterol being important for the consumers, for instance.

From US 2019/263557 A1 an imitation egg product is known, wherein an egg-white material and an egg-yolk material made of artificial, synthetic or otherwise processed ingredients are stored in a shell. The imitation egg is assembled in the shell by providing a base cup comprising the yolk-component and a top cup comprising the white-component.

WO 2019/038794 A discloses a vegan hard-boiled egg comprising an albumen-like phase and a yolk-like phase. The albumen-like phase comprises a powdered component, water, a plant gelling agent and calcium carbonate. The yolk-like phase comprises an oil in water emulsion, water, a legume flour or cereal flour, salt, and a plant gelling agent. In order to prepare said vegan egg, a melted mixture comprising the yolk-like phase is poured into spherical molds in order to obtain yolk-like solid compounds and a melted mixture comprising the albumen-like phase is poured into a mold having cavities. Subsequently, the solidified yolk-like phase is inserted into the cavities containing the albumen-like phase.

Several disadvantages are associated with vegan products and their method of production known in the state of the art. For instance, the products can have a watery consistency, wherein water escapes during their storage, leaving liquid in the packing of the product as it is known with tofu, for example. Furthermore, when the individual components such as the egg-white and the egg-yolk have to be produced separately and thereafter be assembled together, the production is rendered cumbersome.

### SUMMARY OF THE INVENTION

It is an object of the present invention to provide a vegan food product and a method of production that overcomes the drawbacks of the prior art. In particular, it is an object to provide a vegan food product having an improved texture and whose production is simplified.

This object is achieved with a vegan food product according to claim 1. In particular, a vegan food product, in particular a vegan hard-boiled egg, is provided, wherein the vegan food product comprises at least one outer layer and at least one inner core. The inner core is surrounded by the outer layer. The inner core comprises at least one vegan fibre and the outer layer comprises at least one vegan fibre. The vegan fibre of the inner core comprises a water-binding capacity of 40 g/g or less. The vegan fibre of the inner core preferably comprises a water-binding capacity of 30 g/g or less. More preferably, the vegan fibre of the inner core comprises a water-binding capacity of 20 g/g or less. Particularly preferably, the vegan fibre of the inner core comprises a water-binding capacity of 15 g/g or less. Moreover, the vegan fibre of the outer layer comprises a water-binding capacity of 40 g/g or less. Preferably, the vegan fibre of the outer layer comprises a water-binding capacity of 30 g/g or less. More preferably, the vegan fibre of the outer layer comprises a water-binding capacity of 25 g/g or less.

The water-binding capacity (WBC) is defined as the potential to absorb water and to hold this water during or after treatment with external forces such as pressure, centrifugation or heat. The water-binding capacity is determined according to the AACC method 56-20, mod. (modified), and is defined as follows:

$$WBC = \frac{used water [ in gram ] - filtered water [ in gram ]}{2. gram ( vegan fibre )} ,$$

wherein the used water corresponds to 40.00 gram of water.

The WBC is determined as follows:
(1) 2.00 gram of the vegan fibre is dispersed in 40.00 gram of demineralized water.
(2) Thereafter, the dispersion is allowed to rest for 10 minutes.
(3) Thereafter, the dispersion is centrifuged for 15 minutes at 1000 g.
(4) Thereafter, the supernatant is removed by filtration and is weighted, whereby the weight of the filtered water is obtained.
(5) Thereafter, the WBC is calculated using the above formula.

In other words, the water-binding capacity reflects the ability of the vegan fibre to bind or retain a given amount of water.

To this end it is preferred to use a centrifuge with an acceleration of at least 1000 g. It is furthermore preferred that the dispersion is generated in a centrifuge beaker. The centrifuge beaker preferably has a capacity of at least 50 millilitre. The weight of the filtered water is preferably determined with a scale having at least two digits after the decimal point. Moreover, it is preferred that the supernatant is filtered through a filter plate with a filter paper, wherein a preferred pore size of the filter paper is 8 micrometer.

The following example shall illustrate the determination of the water-binding capacity of the vegan fibre “VITACEL® Oat Fiber HF 100”, wherein the weight of the filtered water was measured to be 36.00 gram:

$$WBC = \frac{used water [ in gram ] - filtered water [ in gram ]}{2. gram ( vegan fibre )} = \frac{40. gram - 36. gram}{2. gram ( vegan fibre )} = 2. \frac{g}{g} .$$

That is, the vegan fibre “VITACEL® Oat Fiber HF 100” comprises a water-binding capacity of 2.0 g/g, i.e. a water-binding capacity of 2.0 gram of water per gram of the vegan fibre.

Unlike thickening agents or gelling agents, also known as hydrocolloids, that bind water and form gels, for instance, the vegan fibres in the outer layer and the inner core are capable of absorbing water. As a result, the vegan fibres according to the invention give a perceived dryness and improve the texture of the vegan food product since less free water or unbound water is left in the vegan food product. This is in clear contrast to products merely comprising gelling agents or thickenings agents such as pectin or konjac flour, which result in a gum-like texture and tend to liberate the water being bound during storage of the product.

Hence, the vegan fibres according to the invention preferably are not gelling agents and/or thickening agents. Additionally or alternatively, the vegan fibres are preferably unsuitable for gelation and/or for the formation of hydrocolloidal matrices or gel matrices.

The vegan product preferably is a vegan hard-boiled egg. Hence, the outer layer preferably corresponds to a vegan albumin-like mass and the inner core preferably corresponds to a vegan yolk-like mass.

The vegan hard-boiled egg could be provided as a so-called picnic egg or a so-called long egg. A picnic egg is understood as having an essentially oval shape, wherein the inner core is provided with an essentially round shape and the surrounding outer layer has an essentially oval shape. A long egg is understood as having an elongated shape, wherein the inner core and the surrounding outer layer have an elongated shape as well.

The vegan fibre of the inner core preferably comprises a water-binding capacity in the range of 0 g/g to 26 g/g, such as in the range of 0 g/g to 25 g/g, for example in the range of 0 g/g to 15 g/g, more preferably in the range of 0 g/g to 5 g/g. For instance, if the vegan fibre of the inner core is a water-soluble fibre, it has a water-binding capacity of 0 g/g.

Additionally or alternatively, the vegan fibre of the outer layer preferably comprises a water-binding capacity in the range of 2 g/g to 26 g/g such as in the range of 2 g/g to 25 g/g.

The vegan fibre of the inner core preferably comprises a water activity in the range of 2% to 10%, more preferably in the range of 3% to 8%.

Additionally or alternatively, the vegan fibre of the outer layer preferably comprises a water activity in the range of 2% to 10%, more preferably in the range of 3% to 8%.

The water activity is measured by a water activity measuring device as it is commonly known in the state of the art. In the present invention, the water activity was measured according to the standard ISO 18787:2017 “Foodstuffs-Determination of water activity”. Furthermore, the water activity was measured using a resistive electrolytic hygrometer. Here, the device “LabMaster-aw neo” made by Novasina was used. The water activity (also aW value or Activity of Water) of a food is a measure of the “available” or “active” water in contrast to the mere indication of the water content. The importance of this parameter results from the fact that the water activity influences the growth of microorganisms, the course of chemical processes such as fat oxidation and non-enzymatic browning, the activity of enzymes and the physical properties of the food.

The vegan fibre of the inner core and/or the outer layer preferably is a fibre of non-animal origin. The vegan fibre of the inner core and/or the outer layer particularly preferably is a plant-based fibre and/or a yeast-based fibre and/or a fungus-based fibre. It is furthermore preferred that the vegan fibre of the inner core and/or the outer core is gluten-free. In addition, it is preferred that the vegan fibre of the inner core and the vegan fibre of the outer layer differ from one another.

The vegan fibre of the inner core preferably is water-soluble and/or water-insoluble. It is particularly preferred that the vegan fibre of the inner core is comprised of a mainly soluble vegan fibre. A mainly soluble vegan fibre is understood as a vegan fibre having a soluble fibre portion of 60% or more, such as 70% or more or 80% or more, of the overall fibre content of said vegan fibre. The vegan fibre of the inner core preferably is a maize fibre and/or soy fibre and/or a citrus fruit peel fibre and/or an oat fibre and/or a pea fibre and/or a chickpea fibre and/or wheat fibre and/or a potato fibre and/or a rice fibre.

The vegan fibre of the outer layer preferably is water-insoluble and/or water soluble. It is particularly preferred that the vegan fibre of the outer layer is comprised of a mainly insoluble vegan fibre portion of 60% or more, such as 70% or more or 80% or more, of the overall fibre content of said vegan fibre.

The vegan fibre of the outer layer preferably is a wheat fibre and/or a rice fibre and/or an oat fibre and/or a potato fibre and/or a pea fibre and/or a teff fibre and/or a citrus fruit peel fibre and/or maize fibre and/or soy fibre.

The vegan fibre of the inner core particularly preferably is a mainly soluble maize fibre or maize-based fibre. In fact, said mainly soluble maize fibre or maize-based fibre preferably has a soluble fibre portion in the range of 60% to 70% of the overall fibre content of said maize fibre or maize-based fibre, respectively. The maize-based fibre is a maize fibre being extracted from the whole kernel of corn and is based on the raw material corn. The maize fibre or maize-based fibre can be a commercially available fibre such as Promitor® from Tate and Lyle. Since Promitor® is a soluble fibre it has a water-binding capacity of 0 g/g. Another preferred (mainly insoluble) vegan fibre of the inner core is a rice fibre such as VITACEL® Rice Fibre 310 rom J. Rettenmaier & Söhne (JRS), which has a water-binding capacity of 3.8 g/g. Further vegan fibres are of course likewise conceivable. Another preferred (mainly insoluble) vegan fibre of the inner core is a carrot fibre such as KaroPRO 1-26 from FoodSolutionsTeam B.V, which has a water-binding capacity of 26 g/g. Another preferred vegan fibre is Promitor® SGF 70R from Tate and Lyle, which is a corn fibre that is soluble and thus has a water-binding capacity of 0 g/g.

The vegan fibre of the outer layer particularly preferably is a wheat fibre such as VITACEL® Wheat Fiber WF 200 from J. Rettenmaier & Söhne (JRS). Said wheat fibre preferably has a water-binding capacity of 8.6 g/g. Another preferred vegan fibre of the outer layer is an oat fibre such as VITACEL® Oat Fibre HF 100, which has a water-binding capacity of 2.0 g/g. Another preferred oat fibre is the VITACEL® Oat Fibre HF 200, which has a water-binding capacity of 6.8 g/g. Another preferred vegan fibre of the outer layer is a citrus fibre such as the citrus fiber HERBACEL® AQ® Plus Citrus-F, which has a water-binding capacity of 25 g/g. Another preferred vegan fibre of the outer layer is a rice fibre such as VITACEL® Rice Fibre 310, which has a water-binding capacity of 3.8 g/g. Further vegan fibres are of course likewise conceivable. For instance KaroPRO 1-26 from FoodSolutionsTeam B.V. KaroPRO 1-26 has a water-binding capacity of 26 g/g.

The inner core preferably comprises between 1% by weight to 20% by weight of the vegan fibre per total weight of the inner core. Additionally or alternatively, the outer layer preferably comprises between 0.1% by weight to 6% by weight of the vegan fibre per total weight of the outer layer.

Moreover, it is preferred that the inner core comprises between 5% by weight to 20% by weight of a mainly soluble vegan fibre per total weight of the inner core. The inner core particularly preferably comprises between 6% by weight to 16% by weight, more preferably between 8% by weight to 13% by weight, such as about 11% by weight, of the mainly soluble vegan fibre per total weight of the inner core. Furthermore, in the event that the vegan food product is a picnic egg the inner core particularly preferably comprises between 6% by weight to 16% by weight, more preferably between 8% by weight to 13% by weight, such as about 11% by weight, of the mainly soluble vegan fibre per total weight of the inner core. In the event that the vegan food product is a long egg, the inner core particularly preferably comprises between 6% by weight to 16% by weight, more preferably between 8% by weight to 13% by weight, such as about 10% by weight, of the mainly soluble vegan fibre per total weight of the inner core. It is furthermore preferred that the inner core comprises between 6% by weight to 16% by weight, more preferably between 8% by weight to 13% by weight, such as about 11% by weight, of the soluble maize fibre per total weight of the inner core. Furthermore, in the event that the vegan food product is a picnic egg, the inner core preferably comprises between 6% by weight to 16% by weight, more preferably between 8% by weight to 13% by weight, such as about 11% by weight, of the soluble maize fibre per total weight of the inner core. In the event that the vegan food product is a long egg, the inner core preferably comprises between 6% by weight to 16% by weight, more preferably between 8% by weight to 13% by weight, such as about 10% by weight, of the soluble maize fibre per total weight of the inner core.

However, it is likewise preferred that the inner core comprises between 1% by weight to 6% by weight of a mainly insoluble vegan fibre per total weight of the inner core. Particularly preferably, the inner core comprises between 2% by weight to 4% by weight of the mainly insoluble vegan fibre per total weight of the inner core, such as about 2% by weight of the mainly insoluble vegan fibre per total weight of the inner core. To this end it is particularly preferred that the vegan food product in the form of the picnic egg comprises such a mainly insoluble vegan fibre and/or wherein the vegan food product in the form of the long egg preferably has no insoluble vegan fibres, i.e. is preferably free from insoluble vegan fibres. However, and as mentioned earlier, it is conceivable that the vegan food product in the form of the vegan long egg comprises at least partially insoluble vegan fibres.

That is, it is preferred that the inner core comprises a greater amount of a mainly soluble vegan fibre as compared to a mainly insoluble vegan fibre.

A fibre content of the vegan fibre preferably is in the range of 60% to 85%. A quantification of the fibre content is preferably performed according to the method AOAC 2001.03. For instance, the vegan fibre Promitor® comprises a fibre content of 70% when determined according to the method AOAC 2001.03.

The outer layer particularly preferably comprises between 0.5% by weight to 4% by weight, more preferably between 1% by weight to 2.5% by weight, such as about 1.5% by weight, of the vegan fibre per total weight of the outer layer. Furthermore, in the event of the vegan food product being a vegan picnic egg the outer layer particularly preferably comprises between 0.5% by weight to 4% by weight, more preferably between 1% by weight to 2.5% by weight, such as about 1.5% by weight, of the vegan fibre per total weight of the outer layer. In the event of the vegan food product being a vegan long egg the outer layer particularly preferably comprises between 0.5% by weight to 4% by weight, more preferably between 1% by weight to 2.5% by weight, such as about 2% by weight, of the vegan fibre per total weight of the outer layer.

It is furthermore preferred that the outer layer comprises between 0.5% by weight to 4% by weight, more preferably between 1% by weight to 2.5% by weight, such as about 1.5% by weight, of the wheat fibre, in particular of wheat fibre 200, per total weight of the outer layer. These values are particularly preferred in the event that the vegan food product is a vegan picnic egg. In the event of the vegan food product being a vegan long egg it is preferred that the outer layer comprises between 0.5% by weight to 4% by weight, more preferably between 1% by weight to 2.5% by weight, such as about 2% by weight, of the wheat fibre, in particular of wheat fibre 200, per total weight of the outer layer.

A length of the vegan fibre of the inner core preferably is in the range of 70 micrometer to 400 micrometer. Additionally or alternatively, a length of the vegan fibre of the outer layer preferably is in the range of 70 micrometer to 400 micrometer.

As mentioned earlier, the vegan fibre of the inner core preferably is a mainly soluble corn fibre. Said fibre preferably has a length mainly in the range of 160 to 250 micrometer. The outer layer preferably is a mainly insoluble wheat fibre having a length in the range of 70 to 250 micrometer. It is furthermore preferred that the water-binding capacity of said fibre is 8.6 g/g.

The inner core preferably furthermore comprises at least one of:
one or more gelling agents, the gelling agent preferably being a polysaccharide such as guar gum and/or an algae-based gelling agent, preferred algae-based gelling agents are carrageenan and/or agar agar and/or xanthan and/or alginate;
at least one vegan protein and/or at least one source of vegan protein, the vegan protein preferably being a soy protein and/or a potato protein and/or a wheat protein and/or a pea protein and/or a rice protein and/or a chickpea protein and/or a fababean protein and/or a mungbean protein and/or a pumpkin seed protein and/or a lupin protein and/or the source of vegan protein preferably being algae;
at least one colouring agent, the colouring agent preferably being a natural colorant, particularly preferably beta-carotene and/or turmeric;
water;
at least one source of fat, the source of fat preferably being a vegetable oil and particularly preferably is sunflower oil and/or coconut oil and/or rapeseed oil;
at least one preserving agent, the preserving agent preferably being an acid and particularly preferably being lactic acid of non-animal origin and/or citric acid;
at least one salt, the salt preferably being table salt; and
at least one flavouring agent, the flavouring agent preferably comprises one or more sulphur-compounds and/or a mix containing one or more sulphur-compounds and/or a natural salt such as kala namak.

The one or more gelling agents preferably serve the purpose of providing or participating in a firm and crisp gel-like structure that has a clear and defined break and results in a smoother texture, for instance. The one or more vegan proteins and/or the one or more source of vegan protein preferably serve the purpose of providing a protein content, which is beneficial for nutritional reasons and furthermore improves the texture and consistency, for example. The one or more colouring agents preferably serve the purpose of providing an orange colour and thus to mimic an egg yolk, for instance. The one or more preserving agents preferably serve the purpose of lowering a pH value to prolong shelf-life by making the vegan food product inhospitable to microbes such as a growth of spores to mature microorganisms. The one or more flavouring agent preferably serve the purpose of masking off-notes and providing a sulphur and thus egg-like top note to the vegan food product.

The inner core preferably additionally comprises between 0% by weight to 6% by weight of the gelling agent per total weight of the inner core. The inner core more preferably comprises between 0.2% by weight to 2% by weight of the gelling agent per total weight of the inner core. The inner core particularly preferably comprises between 0.4% by weight to 1.2% by weight such as about 1% by weight of the gelling agent per total weight of the inner core. These values are particularly preferred in the event that the vegan food product is a vegan picnic egg. In the event of the vegan food product being a vegan long egg the inner core preferably comprises between 0.5% by weight to 2.5% by weight such as about 1.3% by weight of the gelling agent per total weight of the inner core Moreover, the inner core particularly preferably comprises carrageenan and agar as gelling agents. It is furthermore preferred that the inner core comprises between 0.2% by weight to 0.6% by weight such as about 0.5% by weight carrageenan per total weight of the inner core and between 0.2% by weight to 0.6% by weight such as about 0.5% by weight agar per total weight of the inner core. These values are particularly preferred in the event that the vegan food product is a vegan picnic egg. In the event that the vegan food product is a vegan long egg it is preferred that the inner core comprises between 0.25% by weight to 1.25% by weight such as about 0.8% by weight carrageenan per total weight of the inner core and between 0.25% by weight to 1.25% by weight such as about 0.5% by weight agar per total weight of the inner core.

The vegan protein preferably is a protein of non-animal origin. The vegan protein particularly preferably is a plant-based protein and/or a yeast-based protein and/or a fungus-based protein. It should furthermore be noted that the vegan protein can be a protein or a protein derivative or an isolate or a concentrate or a flour. The inner core preferably additionally comprises between 15% by weight to 40% by weight of the vegan protein per total weight of the inner core. The inner core more preferably comprises between 17% by weight to 34% by weight of the vegan protein per total weight of the inner core. The inner core particularly preferably comprises between 18% by weight to 30% by weight, for instance between 19% by weight to 26% by weight such as about 23% by weight of the vegan protein per total weight of the inner core. Moreover, the inner core particularly preferably comprises soy protein as the vegan protein. It is furthermore preferred that the inner core comprises between 19% by weight to 26% by weight such as about 23% by weight soy protein per total weight of the inner core. These values are particularly preferred in the event that the vegan food product is a vegan picnic egg. In the event of the vegan food product being a vegan long egg the inner core preferably comprises between 18% by weight to 30% by weight such as about 26% by weight soy protein per total weight of the inner core.

Additionally or alternatively the inner core preferably comprises between 15% by weight to 40% by weight of the source of vegan protein per total weight of the inner core. The inner core more preferably comprises between 17% by weight to 34% by weight of the source of vegan protein per total weight of the inner core. The inner core particularly preferably comprises between 18% by weight to 30% by weight, for instance between 19% by weight to 26% by weight such as about 23% by weight of the source of vegan protein per total weight of the inner core. Moreover, the inner core particularly preferably comprises algae as the source of vegan protein.

It is furthermore preferred that the inner core comprises between 19% by weight to 26% by weight such as about 23% by weight algae per total weight of the inner core. These values are particularly preferred in the event that the vegan food product is a vegan picnic egg. In the event of the vegan food product being a vegan long egg the inner core preferably comprises between 18% by weight to 30% by weight such as about 26% by weight of algae per total weight of the inner core.

Additionally or alternatively, the inner core preferably additionally comprises between 0.01% by weight to 2% by weight of the colouring agent per total weight of the inner core. The inner core more preferably comprises between 0.02% by weight to 1% by weight of colouring agent per total weight of the inner core. The inner core particularly preferably comprises between 0.05% by weight to 0.5% by weight such as about 0.2% by weight of the colouring agent per total weight of the inner core. Moreover, the inner core particularly preferably comprises beta-carotene as the colouring agent. It is furthermore preferred that the inner core comprises between about 0.05% by weight to 0.5% by weight such as about 0.2% by weight beta-carotene per total weight of the inner core. These values are particularly preferred in the event that the vegan food product is a vegan picnic egg. In the event of the vegan food product being a vegan long egg it is particularly preferred that the inner core comprises between about 0.05% by weight to 0.5% by weight such as about 0.4% by weight beta-carotene per total weight of the inner core.

Additionally or alternatively, the inner core preferably additionally comprises between 30% by weight to 80% by weight of water per total weight of the inner core. The inner core more preferably comprises between 40% by weight to 70% by weight of water per total weight of the inner core. The inner core particularly preferably comprises between 45% by weight to 65% by weight such as about 53% by weight of water per total weight of the inner core. These values are particularly preferred in the event that the vegan food product is a vegan picnic egg and/or a vegan long egg.

Additionally or alternatively, the inner core preferably additionally comprises between 2% by weight to 18% by weight of the source of fat per total weight of the inner core. The inner core more preferably comprises between 5% by weight to 15% by weight of the source of fat per total weight of the inner core.

The inner core particularly preferably comprises between 7% by weight to 12% by weight such as about 10% by weight of the source of fat per total weight of the inner core. Moreover, the inner core particularly preferably comprises rapeseed oil as the source of fat. It is furthermore preferred that the inner core comprises between 7% by weight to 12% by weight such as about 10% by weight of rapeseed oil per total weight of the inner core. These values are particularly preferred in the event that the vegan food product is a vegan picnic egg and/or a vegan long egg.

Additionally or alternatively, the inner core preferably additionally comprises between 0.04% by weight to 2% by weight of the preserving agent per total weight of the inner core. The inner core more preferably comprises between 0.1% by weight to 1.5% by weight of the preserving agent per total weight of the inner core. The inner core particularly preferably comprises between 0.4% by weight to 1.2% by weight such as about 0.9% by weight of the preserving agent per total weight of the inner core. Moreover, the inner core preferably comprises lactic acid as the preserving agent. The lactic acid of non-animal origin preferably corresponds to a chemically synthesized lactic acid that has been synthesized with conventional enzymes and/or microorganisms. It is furthermore preferred that the inner core comprises between 0.4% by weight to 1.2% by weight such as about 0.9% by weight of lactic acid per total weight of the inner core. This is particularly preferred in the event that the vegan food product is a vegan picnic egg. In a preferred embodiment of the vegan food product being a vegan long egg no preserving agent, in particular no lactic acid is present. Instead, and as will be outlined in greater detail below, the vegan long egg during its production is preferably subjected to a step of pasteurisation and directly deposited into a package.

Additionally or alternatively, the inner core preferably additionally comprises between 0.1% by weight to 4% by weight of salt per total weight of the inner core. The inner core more preferably comprises between 0.1% by weight to 2% by weight of salt per total weight of the inner core. The inner core particularly preferably comprises between 0.2% by weight to 0.8% by weight such as about 0.5% by weight of salt, in particular of table salt, per total weight of the inner core. This is particularly preferred in the event of the vegan food product being a vegan picnic egg and/or a vegan long egg.

Additionally or alternatively, the inner core preferably additionally comprises between 0.2% by weight to 5% by weight of the flavouring agent by total weight of the inner core.

The inner core more preferably comprises between 0.5% by weight to 2.5% by weight of flavouring agent per total weight of the inner core. The inner core particularly preferably comprises between 0.9% by weight to 1.7% by weight such as about 1.3% by weight of flavouring agent per total weight of the inner core. This is particularly preferred in the event of the vegan food product being a vegan picnic egg. In the event of the vegan food product being a vegan long egg the inner core particularly preferably comprises between 0.6% by weight to 1% by weight of flavouring agent per total weight of the inner core. These amounts preferably depend on the customer desire and the intended end use of the vegan long egg, for instance whether it is used as an egg salad or in sandwiches. Moreover, the inner core preferably comprises a flavour mix containing one or more sulphuric compounds as the flavouring agent. The flavouring agent particularly preferably comprises one or more compounds that simulate the flavour of an animal egg such as a chicken egg.

It should be noted that not all of the above compounds are required in the inner core but can be added in order to meet requirements or desires such as taste, mouthfeel, texture, etc. For instance, the inner core can comprise:
water;
at least one vegan protein and/or at least one source of vegan protein;
at least one vegan fibre; and
at least one gelling agent.

As an example, a preferred inner core preferably comprises the following compounds:
about 65% by weight, in particular 64.87% by weight of water per total weight of the inner core;
about 24% by weight of soy protein such as Supro XT 219D IP as the vegan protein per total weight of the inner core;
about 10% by weight, in particular 10.13% by weight of Promitor® SGF 70R from Tate and Lyle as the vegan fibre per total weight of the inner core; and
about 1% by weight of carrageen such as Ceambloom WD 91-539 from CEAMSA (Compañía Española de Algas Marinas S.A.) as gelling agent per total weight of the inner core.

The inner core particularly preferably comprises the following compounds:
about 11% by weight, in particular 10.83% by weight of the soluble maize fibre such as Promitor® from Tate and Lyle as the vegan fibre per total weight of the inner core; and
about 0.5% by weight, in particular 0.49% by weight of carrageenan as the gelling agent per total weight of the inner core; and
about 23% by weight, in particular 22.80% by weight of the soy protein as the vegan protein per total weight of the inner core; and
about 0.5% by weight, in particular 0.49% by weight of agar agar as another gelling agent per total weight of the inner core; and
0.2% by weight of beta-carotene as the colouring agent per total weight of the inner core; and
about 53% by weight, in particular 52.66% by weight of water per total weight of the inner core; and
about 10% by weight, in particular 9.85% by weight of rapeseed oil as the source of fat per total weight of the inner core; and
about 0.9% by weight, in particular 0.89% by weight of lactic acid as the preserving agent per total weight of the inner core; and
about 0.5% by weight, in particular 0.50% by weight of table salt per total weight of the inner core; and
about 1.3% by weight, in particular 1.29% by weight of one or more sulphur-compounds and/or a mix containing one or more sulphur-compounds as the flavouring agent per total weight of the inner core.
   Said inner core is preferably an inner core of a vegan food product in the form of a vegan picnic egg.

Another particularly preferred inner core of a vegan food product in the form of a vegan picnic egg is as follows:
about 2% by weight of a rice fibre such as VITACEL® Rice Fibre 310 from J. Rettenmaier & Söhne (JRS) as the vegan fibre per total weight of the inner core;
0.5% by weight of carrageenan as the gelling agent per total weight of the inner core;
about 23% by weight, in particular 22.8% by weight of the soy protein as the vegan protein per total weight of the inner core;
about 0.5% by weight of agar agar as another gelling agent per total weight of the inner core;
about 0.4% by weight of beta-carotene as the colouring agent per total weight of the inner core;
about 63% by weight, in particular 63.45% by weight of water per total weight of the inner core;
about 10% by weight, in particular 9.85% by weight of rapeseed oil as the source of fat per total weight of the inner core;
absence of lactic acid as the preserving agent; and
about 0.5% by weight of table salt per total weight of the inner core.

Another particularly preferred inner core of a vegan food product in the form of a vegan picnic egg is as follows:
about 0.8% by weight of a carrot fibre such as KaroPRO 1-26 from FoodSolutionsTeam B.V as the vegan fibre per total weight of the inner core;
0.5% by weight of carrageenan as the gelling agent per total weight of the inner core;
about 23% by weight, in particular 22.8% by weight of the soy protein as the vegan protein per total weight of the inner core;
about 0.5% by weight of agar agar as another gelling agent per total weight of the inner core;
about 0.4% by weight of beta-carotene as the colouring agent per total weight of the inner core;
about 65% by weight, in particular 64.65% by weight of water per total weight of the inner core;
about 10% by weight, in particular 9.85% by weight of rapeseed oil as the source of fat per total weight of the inner core;
absence of lactic acid as the preserving agent; and
about 0.5% by weight of table salt per total weight of the inner core.

A particularly preferred inner core of a vegan food product in the form of a vegan long egg is as follows:
about 10% by weight, in particular 9.8% by weight of the soluble maize fibre such as Promitor® from Tate and Lyle as the vegan fibre per total weight of the inner core;
about 0.8% by weight of carrageenan as the gelling agent per total weight of the inner core;
about 26% by weight, in particular 25.8% by weight of the soy protein as the vegan protein per total weight of the inner core;
about 0.5% by weight of agar agar as another gelling agent per total weight of the inner core;
about 0.4% by weight of beta-carotene as the colouring agent per total weight of the inner core;
about 52% by weight, in particular 52.4% by weight of water per total weight of the inner core;
about 10% by weight, in particular 9.8% by weight of rapeseed oil as the source of fat per total weight of the inner core;
absence of lactic acid as the preserving agent;
about 0.5% by weight of table salt per total weight of the inner core;
between 0.6% by weight to 1% by weight of one or more sulphur-compounds and/or a mix containing one or more sulphur-compounds as the flavouring agent per total weight of the inner core.

The outer layer preferably furthermore comprises at least one of:
one or more colouring agents, the colouring agent preferably being a calcium salt and/or a phosphate-compound and/or a carbonate-compound and/or a metal oxide-compound, the colouring agent particularly preferably being tricalciumphosphate and/or calcium carbonate and/or titanium dioxide;
one or more gelling agents, the gelling agent preferably being a polysaccharide such as guar gum and/or gellan gum and/or an algae-based gelling agent, preferred algae-based gelling agents are carrageenan and/or agar agar and/or xanthan and/or alginate;
at least one salt, the salt preferably being table salt;
at least one plant-based starch, the plant-based starch preferably being based on rice and/or potato and/or maize and/or wheat and/or tapioca;
at least one vegan protein and/or at least one source of vegan protein, the vegan protein preferably being a soy protein and/or a potato protein and/or a wheat protein and/or a pea protein and/or a rice protein and/or a chickpea protein and/or a fababean protein and/or a mungbean protein and/or a pumpkin seed protein and/or a lupin protein and/or the source of vegan protein preferably being algae;
water;
at least one preserving agent, the preserving agent preferably being an acid, particularly preferably lactic acid of non-animal origin and/or citric acid and/or phosphoric acid; and
at least one flavouring agent, the flavouring agent preferably comprises one or more sulphur-compounds and/or a mix containing one or more sulphur-compounds and/or a natural salt such as kala namak.
   Said outer layer is preferably an outer layer of a vegan food product in the form of a vegan picnic egg as well as in the form of a vegan long egg.

The one or more colouring agents preferably serve the purpose of colouring the outer layer, in particular rendering it white opaque. They additionally can serve the purpose of providing an ease of dissolution for the gelling agents such as the carrageenan and gellan gum. Furthermore, they preferably serve the purpose of providing a source of calcium, which is advantageous in view of nutritional aspects.

The one or more gelling agents preferably serve the purpose of providing a firm and crisp gel-like structure which has a clear and defined break. They furthermore preferably serve the purpose of being a stabiliser for the gel-like structure, in particular for providing a soft and thick gel, improve a viscosity and flow during the manufacturing of the vegan food product and enable a more precise dosing (see also further below). The one or more plant-based starches preferably serve the purpose of providing a smooth mouthfeel texture, make the outer layer opaquer and enhance texture. The one or more vegan proteins preferably serve the purpose of increasing a protein content, which is beneficial with regard to nutritional aspects, for instance. The one or more preserving agents preferably serve the purpose of lowering the pH value of the vegan food product to prolong shelf-life by making the vegan food product inhospitable to microbes. The one or more flavouring agents preferably serve the purpose of masking off-notes and providing a sulphur and thus egg-like top note.

The outer layer preferably additionally comprises between 0.5% by weight to 6% by weight of the colouring agent per total weight of the outer layer. The outer layer more preferably comprises between 1% by weight and 4% by weight of colouring agent per total weight of the outer layer. The outer layer particularly preferably comprises between 1.5% by weight and 3.5% by weight such as about 2.5% by weight of colouring agent per total weight of the outer layer. These values are particularly preferred if the vegan food product is a vegan picnic egg. In the event of the vegan food product being a vegan long egg the outer layer particularly preferably comprises between 1% by weight to 3% by weight such as about 1.8% by weight of colouring agent per total weight of the outer layer. Moreover, the outer layer particularly preferably comprises tricalciumphosphate as the colouring agent. It is furthermore preferred that the outer layer comprises between 1.5% by weight and 3.5% by weight such as about 2.5% by weight of tricalciumphosphate per total weight of the outer layer. These values are particularly preferred if the vegan food product is a vegan picnic egg. In the event of the vegan food product being a vegan long egg the outer layer particularly preferably comprises between 1% by weight to 3% by weight such as about 1.8% by weight of tricalciumphosphate per total weight of the outer layer.

The outer layer preferably additionally comprises between 0% by weight to 6% by weight of the gelling agent per total weight of the outer layer. The outer layer more preferably comprises between 1% by weight to 4.5% by weight of the gelling agent per total weight of the outer layer. The outer layer particularly preferably comprises between 1.5% by weight to 3.5% by weight such as about 2.7% by weight of the gelling agent per total weight of the outer layer. These values are particularly preferred if the vegan food product is a vegan picnic egg. In the event of the vegan food product being a vegan long egg the outer layer particularly preferably comprises between 1.5% by weight to 3.5% by weight such as about 2.3% by weight of the gelling agent per total weight of the outer layer.

Moreover, the outer layer particularly preferably comprises carrageenan and gellan gum as the gelling agents. It is furthermore preferred that the outer layer comprises between 1% by weight to 2% by weight such as about 1.6% by weight of carrageenan and between 0.5% by weight to 1.5% by weight such as about 1.06% by weight of gellan gum per total weight of the outer layer. This is particularly preferred in the event that the vegan food product is a vegan picnic egg. In the event of the vegan food product being a vegan long egg the outer layer preferably comprises between 1% by weight to 2% by weight such as about 1.3% by weight of carrageenan and between 0.5% by weight to 1.5% by weight such as about 1% by weight of gellan gum per total weight of the outer layer.

Additionally or alternatively, the outer layer preferably additionally comprises between 0.1% by weight to 4% by weight of salt per total weight of the outer layer. The outer layer more preferably comprises between 0.1% by weight to 2% by weight of salt per total weight of the outer layer. The outer layer particularly preferably comprises between 0.2% by weight to 0.8% by weight such as about 0.5% by weight of salt, in particular of table salt, per total weight of the outer layer. These values are particularly preferred in the event of the vegan food product being a vegan picnic egg and/or a vegan long egg.

Additionally or alternatively, the outer layer preferably additionally comprises between 1% by weight to 10% by weight of plant-based starch per total weight of the outer layer. The outer layer more preferably comprises between 3% by weight to 8% by weight such as about 5% by weight of plant-based starch per total weight of the outer layer. The outer layer particularly preferably comprises between 4% by weight to 6% by weight such as about 5% by weight of plant-based starch per total weight of the outer layer. Moreover, the outer layer particularly preferably comprises rice starch as the plant-based starch. It is furthermore preferred that the outer layer comprises between 4% by weight to 6% by weight such as about 5% by weight of rice starch per total weight of the outer layer. These values are particularly preferred in the event of the vegan food product being a vegan picnic egg. In the event of the vegan food product being a vegan long egg the outer layer preferably comprises between 4% by weight to 7% by weight such as about 6.3% by weight of plant-based starch such as rice starch per total weight of the outer layer.

Additionally or alternatively, the outer layer preferably additionally comprises between 0.5% by weight to 10% by weight of the vegan protein per total weight of outer layer. The outer layer more preferably comprises between 1% by weight and 6% by weight of the vegan protein per total weight of the outer layer. The outer layer particularly preferably comprises between 1% by weight and 4% by weight such as about 1.5% by weight of the vegan protein per total weight of the outer layer. Moreover, the outer layer particularly preferably comprises soy protein as the vegan protein. It is furthermore preferred that the outer layer comprises between 1% by weight and 4% by weight such as about 1.5% by weight of soy protein per total weight of the outer layer. These values are particularly preferred in the event of the vegan food product being a vegan picnic egg. In the event of the vegan food product being a vegan long egg the outer layer comprises between 1% by weight and 4% by weight such as about 3% by weight of soy protein per total weight of the outer layer.

Additionally or alternatively, the outer layer preferably additionally comprises between 0.5% by weight to 10% by weight of the source of vegan protein per total weight of outer layer. The outer layer more preferably comprises between 1% by weight and 6% by weight of the source of vegan protein per total weight of the outer layer. The outer layer particularly preferably comprises between 1% by weight and 4% by weight such as about 1.5% by weight of the source of vegan protein per total weight of the outer layer. Moreover, the outer layer particularly preferably comprises algae as the source vegan protein. It is furthermore preferred that the outer layer comprises between 1% by weight and 4% by weight such as about 1.5% by weight of algae per total weight of the outer layer. These values are particularly preferred in the event of the vegan food product being a vegan picnic egg. In the event of the vegan food product being a vegan long egg the outer layer comprises between 1% by weight and 4% by weight such as about 3% by weight of algae per total weight of the outer layer.

Additionally or alternatively, the outer layer preferably additionally comprises between 60% by weight to 95% by weight of water per total weight of the outer layer. The outer layer more preferably comprises between 75% by weight to 95% by weight of water per total weight of the outer layer. The outer layer particularly preferably comprises between 80% by weight to 90% by weight such as about 85% by weight of water per total weight of the outer layer. These values are particularly preferred in the event of the vegan food product being a vegan picnic egg. In the event of the vegan food product being a vegan long egg the outer layer particularly preferably comprises between 80% by weight to 90% by weight such as about 84% by weight of water per total weight of the outer layer.

Additionally or alternatively, the outer layer preferably additionally comprises between 0.04% by weight to 2% by weight of the preserving agent per total weight of the outer layer. The outer layer more preferably comprises between 0.1% by weight to 1% by weight of the preserving agent per total weight of the outer layer. The outer layer particularly preferably comprises between 0.2% by weight to 0.7% by weight such as about 0.4% by weight of the preserving agent per total weight of the outer layer. Moreover, the outer layer particularly preferably comprises lactic acid as the preserving agent. The lactic acid of non-animal origin preferably corresponds to a chemically synthesized lactic acid that has been synthesized with conventional enzymes and/or microorganisms. It is furthermore preferred that the outer layer comprises between 0.2% by weight to 0.7% by weight such as about 0.4% by weight of lactic acid per total weight of the outer layer. These values are particularly preferred in the event of the vegan food product being a vegan picnic egg. In the event of the vegan food product being a vegan long egg it is preferred that a preserving agent, in particular lactic acid, is absent.

Additionally or alternatively, the outer layer preferably additionally comprises between 0.1% by weight to 5% by weight of the flavouring agent by total weight of the outer layer. The outer layer more preferably comprises between 0.1% by weight to 3% by weight of flavouring agent per total weight of the outer layer. The outer layer particularly preferably comprises between 0.4% by weight to 1.5% by weight such as about 0.8% by weight of flavouring agent per total weight of the outer layer. These values are particularly preferred in the event of the vegan food product being a vegan picnic egg. In the event of the vegan food product being a vegan long egg the outer layer particularly preferably comprises between 0.1% by weight to 0.5% by weight such as about 0.2% by weight of flavouring agent per total weight of the outer layer. Moreover, the outer layer preferably comprises a flavour mix containing one or more sulphuric compounds as the flavouring agent. The flavouring agent particularly preferably comprises one or more compounds that simulate the flavour of an animal egg such as a chicken egg.

It should be noted that not all of the above compounds are required in the outer layer but can be added in order to meet requirements or desires such as taste, mouthfeel, texture, etc. For instance, the outer layer can comprise:
water;
at least one plant-based starch;
at least one vegan fibre; and
at least one gelling agent.

As an example, a preferred outer layer preferably comprises the following compounds:
about 90% by weight, in particular 88.9% by weight of water per total weight of the outer layer;
about 7% by weight of rise starch such as REMY ODR-6 BIO from BENEO GmbH as the plant-based starch per total weight of the outer layer;
about 1.5% by weight, in particular 1.4% by weight of carrageen such as Ceamblom WD 91-539 from CEAMSA (Compañía Española de Algas Marinas S.A.) as the gelling agent per total weight of the outer layer;
about 2% by weight, in particular 1.8% by weight of wheat fibre such as Vitacel WF 200 as the vegan fibre per total weight of the outer layer; and
about 1% by weight, in particular 0.9% by weight of gellan gum such as Kelcogel® F from CP Kelco as the gelling agent per total weight of the outer layer.

The outer layer particularly preferably comprises the following compounds:
about 2.5% by weight, in particular 2.54% by weight of the tricalciumphosphate as the colouring agent per total weight of the outer layer; and
about 1.6% by weight, in particular 1.59% by weight of carrageenan as the gelling agent per total weight of the outer layer; and
about 1.5% by weight, in particular 1.49% by weight of the wheat fibre such as the VITACEL® Wheat Fiber WF 200 from J. Rettenmaier & Söhne (JRS) per total weight of the outer layer; and
about 0.5% by weight, in particular 0.50% by weight of table salt per total weight of the outer layer; and
about 5% by weight, in particular 5.30% by weight of rice starch as the plant-based starch; and
about 1.5% by weight, in particular 1.48% by weight of soy protein per total weight of the outer layer; and
about 85% by weight, in particular 84.82% by weight of water per total weight of the outer layer; and
about 0.4% by weight, in particular 0.42% by weight of lactic acid as the preserving agent per total weight of the outer layer; and
about 1% by weight, in particular 1.06% by weight of gellan gum as another gelling agent per total weight of the outer layer; and
about 0.8% by weight, in particular 0.80% by weight of one or more sulphur-compounds and/or a mix containing one or more sulphur-compounds as the flavouring agent per total weight of the outer layer.

The above outer layer particularly preferably is an outer layer of a vegan food product in the form of a vegan picnic egg. A particularly preferred outer layer of a vegan food product in the form of a vegan long egg comprises the following compounds:
1.8% by weight of tricalciumphosphate as the colouring agent per total weight of the outer layer;
1.3% by weight of carrageenan as the gelling agent per total weight of the outer layer;
2% by weight of the wheat fibre such as the VITACEL® Wheat Fiber WF 200 from J. Rettenmaier & Söhne (JRS) per total weight of the outer layer;
0.5% by weight of table salt per total weight of the outer layer; and about 6% by weight, in particular 6.3% by weight of rice starch as the plant-based starch; and
3% by weight of soy protein per total weight of the outer layer; and
about 84% by weight, in particular 83.9% by weight of water per total weight of the outer layer; and
absence of lactic acid as the preserving agent; and
1% by weight of gellan gum as another gelling agent per total weight of the outer layer; and
0.2% by weight of one or more sulphur-compounds and/or a mix containing one or more sulphur-compounds as the flavouring agent per total weight of the outer layer.

Another preferred example of an outer layer of a vegan food product in the form of a vegan picnic egg comprises the following compounds:
about 86% by weight, in particular 85.91% by weight of water per total weight of the outer layer;
about 5.3% by weight of rice starch as the plant-based starch per total weight of the outer layer;
about 2.6% by weight, in particular 2.54% by weight of tricalciumphosphate as the colouring agent per total weight of the outer layer;
about 1.6% by weight, in particular 1.59% by weight of carrageenan as the gelling agent per total weight of the outer layer;
about 1% by weight of the a carrot fibre such as KaroPRO 1-26 from FoodSolutionsTeam B.V. as the vegan fibre per total weight of the outer layer;
about 1.5% by weight, in particular 1.48% by weight of soy protein as the vegan protein per total weight of the outer layer;
about 1% by weight, in particular 1.06% by weight of gellan gum as the gelling agent per total weight of the outer layer;
about 0.2% by weight of flavouring agent per total weight of the outer layer;
about 0.5% by weight of table salt per total weight of the outer layer;
about 0.4% by weight, in particular 0.42% by weight of lactic acid as the preserving agent per total weight of the outer layer.

Another preferred example of an outer layer of a vegan food product in the form of a vegan picnic egg comprises the following compounds:
about 86% by weight, in particular 85.61% by weight of water per total weight of the outer layer;
about 5.3% by weight of rice starch as the plant-based starch per total weight of the outer layer;
about 2.6% by weight, in particular 2.54% by weight of tricalciumphosphate as the colouring agent per total weight of the outer layer;
about 1.6% by weight, in particular 1.59% by weight of carrageenan as the gelling agent per total weight of the outer layer;
about 1.3% by weight of VITACEL® Rice Fibre 310 from J. Rettenmaier & Söhne (JRS) as the vegan fibre per total weight of the outer layer;
about 1.5% by weight, in particular 1.48% by weight of soy protein as the vegan protein per total weight of the outer layer;
about 1% by weight, in particular 1.06% by weight of gellan gum as the gelling agent per total weight of the outer layer;
about 0.2% by weight of flavouring agent per total weight of the outer layer;
about 0.5% by weight of table salt per total weight of the outer layer;
about 0.4% by weight, in particular 0.42% by weight of lactic acid as the preserving agent per total weight of the outer layer.

The inner core and/or the outer layer preferably is free of emulsifiers. In fact, the vegan proteins and/or the source of vegan proteins and the vegan fibres provide enough stability such that no emulsifier is needed.

In another aspect, a method of producing a vegan food product, in particular a vegan hard-boiled egg and/or preferably a vegan food product as described above, is provided. The method comprises the steps of i) providing at least one outer layer from a first mixture, and ii) providing at least one inner core from a second mixture. The inner core is surrounded by the outer layer. The inner core comprises at least one vegan fibre. Additionally, the outer layer comprises at least one vegan fibre. The vegan fibre of the inner core comprises a water-binding capacity of 40 g/g or less. Preferably, the vegan fibre of the inner core comprises a water-binding capacity of 30 g/g or less. More preferably, the vegan fibre of the inner core comprises a water-binding capacity of 20 g/g or less. Particularly preferably, the vegan fibre of the inner core comprises a water-binding capacity of 15 g/g or less. The vegan fibre of the outer layer comprises a water-binding capacity of 40 g/g or less. Preferably, the vegan fibre of the outer layer comprises a water-binding capacity of 30 g/g or less. More preferably, the vegan fibre of the outer layer comprises a water-binding capacity of 25 g/g or less.

The first mixture from which the outer layer is produced preferably comprises the vegan fibre of the outer layer. Likewise, the second mixture from which the inner core is produced preferably comprises the vegan fibre of the inner core. As mentioned initially, the vegan fibres according to the invention are capable of absorbing water. As such, they also influence the characteristics of the mixtures they are provided in. For instance, they affect the flow behavior of the mixtures, in particular a viscosity. As a result, and as will be explained in greater detail below, the first mixture and the second mixture can be deposited in at least one deposition step, preferably in a single deposition step.

As such, it is preferred that the first mixture and the second mixture at least in the deposition step are able to flow while being rather viscous. In fact, it is preferred that the first mixture and the second mixture at least in the deposition step are more viscous than cream, for example.

Further advantages of the vegan fibres are for instance the prevention of the formation of a thin water and/or oil film on a surface of the mixtures which otherwise takes place more distinctly due to condensation and separation. Further advantages of the absorption of this “leftover oil and water” is furthermore notable in the final vegan food product, when it has been stored for a few days. In addition, the presence of the vegan fibre in the outer layer makes it slightly thicker and improves a precision deposition, see further below.

The vegan food product being produced according to the method particularly preferably corresponds to the vegan food product that has been described previously. As such, any explanations made herein with regard to the vegan food product preferably likewise apply to the method of producing the vegan food product and to the vegan food product being produced according to the method and vice versa.

That is, the first mixture preferably furthermore comprises at least one of:
one or more colouring agents, the colouring agent preferably being a calcium salt and/or a phosphate-compound and/or a carbonate-compound and/or a metal oxide-compound, the colouring agent particularly preferably being tricalciumphosphate and/or calcium carbonate and/or titanium dioxide;
one or more gelling agents, the gelling agent preferably being a polysaccharide such as guar gum and/or gellan gum and/or an algae-based gelling agent, preferred algae-based gelling agents are carrageenan and/or agar agar and/or xanthan and/or alginate;
at least one salt, the salt preferably being table salt;
at least one plant-based starch, the plant-based starch preferably being based on rice and/or potato and/or maize and/or wheat and/or tapioca;
at least one vegan protein and/or at least one source of vegan protein, the vegan protein preferably being a soy protein and/or a potato protein and/or a wheat protein and/or a pea protein and/or a rice protein and/or a chickpea protein and/or a fababean protein and/or a mungbean protein and/or a pumpkin seed protein and/or a lupin protein and/or the source of vegan protein preferably being algae;
water;
at least one preserving agent, the preserving agent preferably being an acid, particularly preferably lactic acid of non-animal origin and/or citric acid and/or phosphoric acid; and
at least one flavouring agent, the flavouring agent preferably comprising one or more sulphur-compounds and/or a mix containing one or more sulphur-compounds and/or a natural salt such as kala namak.

To this end it is particularly preferred to prepare the first mixture by providing a solution comprising water and preferably additionally the preserving agent, preferably lactic acid, in a first step. Thereafter, it is preferred to add the vegan fibre and the colouring agent and/or the gelling agent and/or the salt and/or the plant-based starch and/or the vegan protein and/or the source of vegan protein and/or the flavouring agent to said solution in a second step, whereby the first mixture is generated. It is furthermore preferred to stir said first mixture during said second step.

The second mixture preferably furthermore comprises at least one of:
one or more gelling agents, the gelling agent preferably being a polysaccharide such as guar gum and/or an algae-based gelling agent, preferred algae-based gelling agents are carrageenan and/or agar agar and/or xanthan and/or alginate;
at least one vegan protein and/or at least one source of vegan protein, the vegan protein preferably being a soy protein and/or a potato protein and/or a wheat protein and/or a pea protein and/or a rice protein and/or a chickpea protein and/or a fababean protein and/or a mungbean protein and/or a pumpkin seed protein and/or a lupin protein and/or the source of vegan protein preferably being algae;
at least one colouring agent, the colouring agent preferably being a natural colorant, particularly preferably beta-carotene and/or turmeric;
water;
at least one source of fat, the source of fat preferably being a vegetable oil and particularly preferably is sunflower oil and/or coconut oil and/or rapeseed oil;
at least one preserving agent, the preserving agent preferably being an acid and particularly preferably being lactic acid and/or citric acid;
at least one salt, the salt preferably being table salt; and
at least one flavouring agent, the flavouring agent preferably comprising one or more sulphur-compounds and/or a mix containing one or more sulphur-compounds and/or a natural salt such as kala namak.

To this end it is particularly preferred to prepare the second mixture by providing a solution comprising water in a first step. Thereafter, it is preferred to add the vegan fibre and the gelling agent and/or the vegan protein and/or the source of vegan protein and/or the colouring agent and/or the source of fat and/or the preserving agent and/or the salt and/or the flavouring agent to said solution in a second step, whereby the second mixture is generated. It is furthermore preferred to stir said second mixture during the second step.

As mentioned earlier, the first mixture and the second mixture are preferably deposited in at least one deposition step, preferably in one deposition step. That is, it is preferred to provide both mixtures in a single deposition step. To this end the first mixture and the second mixture are preferably deposited in the at least one or one deposition step such, that the inner core is surrounded by the outer layer.

The first mixture is preferably associated with a first kinematic viscosity and the second mixture is associated with a second kinematic viscosity at least in the deposition step. A difference between the first kinematic viscosity and the second kinematic viscosity at least in the deposition step preferably is 40′000 cSt or less, more preferably 20′000 cSt or less. Additionally or alternatively the difference between the first kinematic viscosity and the second kinematic viscosity at least in the deposition step preferably is 2′000 cSt or more, more preferably 5′000 cSt or more.

The kinematic viscosities were determined immediately after the first mixture and the second mixture reached their respective temperatures at which their deposition in the deposition step took place. The kinematic viscosities were measured using a Bostwick Consistometer at 30 seconds and by pouring the first and second mixtures into a holding chamber of the Consistometer immediately after reaching their respective deposition temperatures.

In another aspect, a method of producing a vegan food product, in particular a vegan hard-boiled egg and/or preferably a vegan food product as described above, is provided. The method comprises the steps of i) preparing at least one outer layer from a first mixture, and ii) preparing at least one inner core from a second mixture. The first mixture and the second mixture are deposited in at least one deposition step, particularly preferably in one deposition step, such, that the inner core is surrounded by the outer layer. The first mixture is associated with a first kinematic viscosity and the second mixture is associated with a second kinematic viscosity at least in the deposition step. A difference between the first kinematic viscosity and the second kinematic viscosity at least in the deposition step is 40′000 cSt or less, more preferably 20′000 cSt or less. Additionally or alternatively the difference between the first kinematic viscosity and the second kinematic viscosity at least in the deposition step is 2′000 cSt or more, more preferably 5′000 cSt or more.

The first kinematic viscosity at least in the deposition step preferably is in the range of 20′000 cSt to 40′000 cST, more preferably in the range of 25′000 cST to 35′000 cST. The second kinematic viscosity at least in the deposition step preferably is in the range of 5′000 cST to 25′000 cST, more preferably in the range of 9′000 cST to 15′000 cST.

Additionally or alternatively, the first mixture preferably has a flow path in the range of 6 centimeter to 12 centimeter, more preferably in the range of 7 centimeter to 11 centimeter such as between 8 centimeter to 10 centimeter. In particular, in the event of the vegan food product being a vegan picnic egg it is preferred that the first mixture has a flow path in the range of 8 centimeter to 12 centimeter, more preferably between 9 centimeter and 11 centimeter such as about 10 centimeter. In the event of the vegan food product being a vegan long egg it is preferred that the first mixture has a flow path in the range of 6 centimeter to 10 centimeter, more preferably between 7 centimeter and 9 centimeter such as about 8 centimeter.

Additionally or alternatively, the second mixture preferably has a flow path in the range of 1.5 centimeter to 4.5 centimeter, more preferably in the range of 2.5 centimeter to 3.5 centimeter. In particular, in the event of the vegan food product being a vegan picnic egg it is preferred that the second mixture has a flow path in the range of 2.5 centimeter to 4.5 centimeter, in particular about 3.5 centimeter. In the event of the vegan food product being a vegan long egg it is preferred that the second mixture has a flow path in the range of 1.5 centimeter to 3.5 centimeter, in particular about 2.5 centimeter.

The flow paths of the first mixture and the second mixture are determined with a Bostwick viscosity consistometer CSC Scientific Company and according to the following procedure:
1) Prepare a water bath at 20° C. large enough that the Bostwick can be submerged.
2) Place Bostwick in water bath for 15 minutes.
3) Place Bostwick on countertop and level the Bostwick both lengthwise and widthwise by adjusting the screws of the Bostwick until the bubble of the level is between the two center dark lines of the Bostwick.
4) Close the gate of the Bostwick and click the lever of the Bostwick into place.
5) Check temperature of the sample before measuring the flow path; the temperature of the sample shall be at 85° C.
6) Zero a timer.
7) Stir the sample with a spatula, then pour said sample into a reservoir created by the gate, leveling off the sample with the spatula.
8) Simultaneously, flip the lever to open the gate and start the timer.
9) Stop the timer at 30 seconds and record the measurement.
10) Perform two measurements within 0.5 cm of each other per sample
11) Rinse Bostwick and dry completely between measurements.

The above procedure is performed for the first mixture and the second mixture separately. In any case it is preferred that the first mixture is preferably prepared at room temperature. Additionally or alternatively it is preferred that the second mixture is heated during its preparation. In particular, it is preferred that the second mixture is heated to a temperature in the range of 40° C. to 50° C. during its preparation. However, it is likewise preferred that the second mixture is not heated during its preparation and/or that the second mixture is prepared at room temperature. Additionally or alternatively the first mixture is preferably heated after its preparation preferably to a temperature in the range of 90° C. to 95° C. or to a temperature in the range of 100° C. to 120° C. such as to a temperature of about 115° C. Additionally or alternatively the second mixture is preferably heated after its preparation to a temperature preferably being in the range of 80° C. to 90° C. or to a temperature in the range of 100° C. to 120° C. such as to a temperature of about 115° C.

The room temperature preferably is in the range of 20° C. to 25° C. During its preparation, the second mixture is preferably heated to a temperature at which a denaturisation of the vegan protein being present in the second mixture occurs. After its preparation, the first mixture is preferably heated to a temperature at which a denaturisation of the vegan protein being present in the first mixture occurs. The second mixture is preferably heated after its preparation to a temperature that is higher than the temperature at which the second mixture has been prepared.

The first mixture and the second mixture are preferably deposited in the deposition step from a depositor comprising a first deposition nozzle for depositing the first mixture and a second deposition nozzle for depositing the second mixture.

The first and second mixtures being deposited can be understood as being dosed. That is, it is preferred that a dose of the first mixture and a dose of the second mixture are deposited or dosed in the deposition step.

The first deposition nozzle and the second deposition nozzle are preferably arranged concentrically with respect to one another. To this end it is particularly preferred that the first deposition nozzle concentrically surrounds the second deposition nozzle. The depositor preferably corresponds to a depositor as it is known in the state of the art.

The first mixture and the second mixture are preferably at least temporarily deposited simultaneously in the deposition step.

It is preferred that the deposition step comprises several phases. In fact, it is preferred that the deposition of the first mixture starts before the deposition of the second mixture in a starting phase. The starting phase preferably lasts between 0.1 seconds to 1.5 seconds. Additionally or alternatively the starting phase preferably lasts at least 0.1 seconds. It is furthermore preferred that the starting phase is followed by an intermediate phase, wherein the first mixture and the second mixture are deposited simultaneously. The intermediate phase preferably lasts between 0.8 seconds to 4 seconds. Additionally or alternatively it is preferred that the intermediate phase lasts at least 0.8 seconds. It is furthermore preferred that the intermediate phase is followed by a final phase, wherein only the first mixture is deposited. The final phase preferably lasts between 0.1 seconds to 2 seconds. Additionally or alternatively the final phase preferably lasts at least 0.1 seconds.

The first mixture and the second mixture being at least temporarily deposited simultaneously preferably corresponds to a deposition of these mixtures in the intermediate phase of the deposition step. Said simultaneous deposition during the intermediate phase of the deposition step is particularly preferably present in the event that the vegan food product in the form of the vegan picnic egg is produced. In the production of the vegan food product in the form of the vegan long egg it is preferred that a simultaneous deposition of the first mixture and second mixture takes place during the entire deposition step, i.e. during the starting phase, the intermediate phase as well as the final phase. That is, the deposition step in the production of the vegan long egg preferably is a continuous process until a batch is done. Here, said deposition step can be a continuous process since a package the first and second mixtures are deposited in (see below) is preferably squeezed off through a clip tie system, so the first and last few centimeters of the vegan long egg are wrinkled and rounded off.

The first mixture is preferably deposited in the deposition step at a temperature in the range of 76° C. to 93° C. Additionally or alternatively the second mixture is preferably deposited in the deposition step at a temperature in the range of 83° C. to 86° C. or in the range of 100° C. to 115° C.

It is furthermore preferred that the first mixture and the second mixture are deposited in the deposition step into one or more moulds.

The mould preferably has the shape of a picnic egg and/or an oval shape in the event that the vegan food product corresponds to a vegan hard-boiled picnic egg. The mould preferably has the shape of a long egg and/or an elongated shape, preferably a cylindrical shape, in the event that the vegan food product corresponds to a vegan hard-boiled long egg.

In any case it is preferred that the one or more moulds are cooled after exiting the depositor. The one or more moulds are preferably cooled for 30 minutes or more.

When the moulds are cooled it is preferred to unmould the vegan food product from the moulds.

The vegan food product is preferably packaged after being unmoulded from the mould, by a package.

However, instead of depositing the mixtures into moulds it is likewise conceivable that the first mixture and the second mixture are deposited directly into the package. This direct deposition into the final package is particularly preferred in the event of the vegan food product being a vegan long egg. That is, in the event of the vegan food product being a vegan long egg it is preferred that the package serves as the mould, wherein the mixtures are directly filled into said mould without the need to unmould the vegan food product later on.

The package preferably comprises or consists of plastics and/or is a bio-based or renewable package and particularly preferably is skin film and/or comprises or consists of bioplastics, alginates, or waxes. Such a package is preferred in the event of the vegan food product being packaged after being unmoulded from the mould or in the event of the vegan food product being directly deposited into the package.

After being packaged, the vegan food product preferably is subjected to at least one step of preservation and/or sterilisation, in particular to a high pressure processing treatment. The high pressure processing treatment is preferably performed at 6000 bar for 3 minutes.

In another aspect, the vegan fibre is used for producing a vegan food product, in particular a vegan hard-boiled egg particularly preferably as described above. The vegan fibre comprises a water-binding capacity of 40 g/g or less, preferably of 30 g/g or less, more preferably of 25 g/g or less.

The vegan fibre preferably corresponds to the vegan fibre of the inner core as described above, wherein the vegan fibre is used to produce a vegan yolk-like mass or substitute. It is however likewise preferred that the vegan fibre corresponds to the vegan fibre of the outer layer as described above, and wherein the vegan fibre is used to produce a vegan albumin-like mass or substitute. As such, it is preferred that any explanations made herein above regarding the vegan food product or the method of producing the vegan food product likewise apply to the use of the vegan fibre and vice versa.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a photograph of a vegan food product according to a first embodiment;

FIG. 2 shows a photograph of vegan food products according to a second embodiment;

FIG. 3 shows a photograph of vegan food products according to a third embodiment;

FIG. 4 shows a photograph of a vegan food product according to a fourth embodiment;

FIG. 5 shows a photograph of vegan food products according to a fifth embodiment;

FIG. 6 shows a photograph of vegan food products according to a sixth embodiment;

FIG. 7 shows a photograph of an outer layer of a vegan food product according to a first embodiment;

FIG. 8 shows a photograph of an outer layer of a vegan food product according to a second embodiment;

FIG. 9 shows a photograph of an outer layer of a vegan food product according to a third embodiment;

FIG. 10 shows a photograph of an outer layer of a vegan food product according to a fourth embodiment;

FIG. 11 shows a photograph of an outer layer of a vegan food product according to a fifth embodiment;

FIG. 12 shows a photograph of an outer layer of a vegan food product according to a sixth embodiment;

FIG. 13 shows a photograph of an inner core of a vegan food product according to a first embodiment;

FIG. 14 shows a photograph of an inner core of a vegan food product according to a second embodiment;

FIG. 15 shows a photograph of an inner core of a vegan food product according to a third embodiment;

FIG. 16 shows a photograph of vegan food products according to a seventh embodiment;

FIG. 17 shows a photograph of vegan food products according to an eight embodiment;

FIG. 18 shows a photograph of a vegan food product according to a seventh embodiment;

FIGS. 19a-19c show photographs of different steps of the preparation of a vegan food product of the state of the art according to the method of the invention.

### DESCRIPTION OF PREFERRED EMBODIMENTS

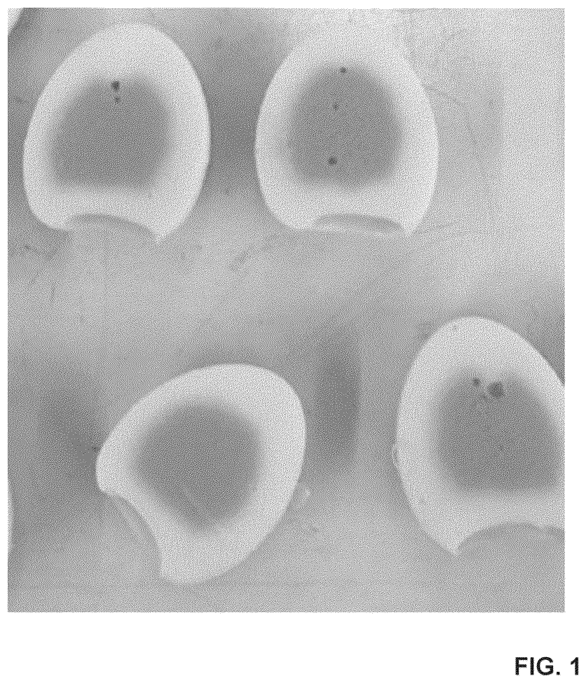

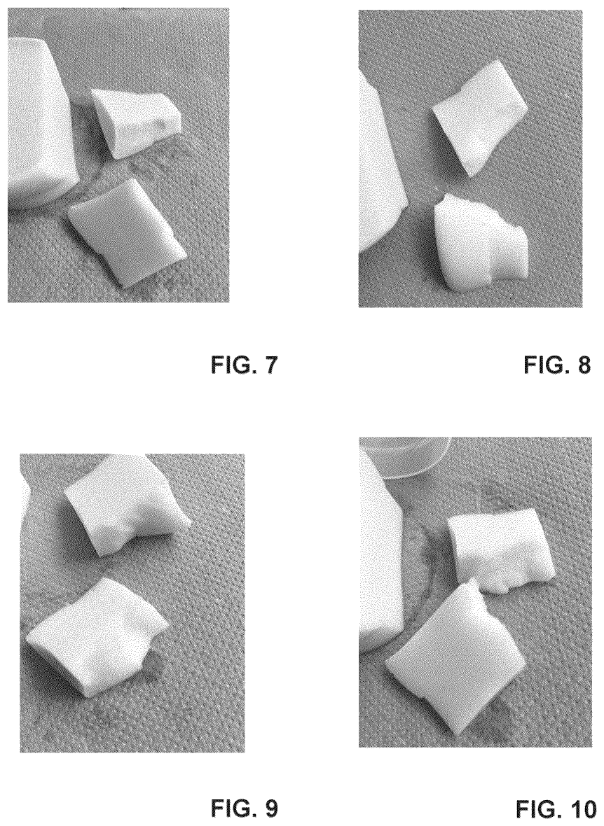

FIGS. 1 to 6 and 16 to 17 depict photographs of vegan food products having different compositions and that were prepared with different method parameters, respectively. The vegan food products in these figures correspond in each case to a vegan hard-boiled picnic egg having an inner core, a vegan yolk-like mass, being surrounded by an outer layer, a vegan albumin-like mass. FIGS. 7 to 15 depict photographs of inner cores and outer layers of vegan food products, wherein the inner cores and the outer layers have different compositions.

To this end FIG. 1 depicts a vegan hard-boiled egg whose inner core and outer layer comprise the compositions according to the invention. Furthermore, the inner core and the outer layer have been prepared according to the method of the invention. As becomes readily apparent from FIG. 1, said vegan hard-boiled egg perfectly mimics a hard-boiled egg of a real chicken.

The outer layer was prepared from a first mixture comprising:
84.82% by weight of water per total weight of the outer layer;
1.59% by weight of carrageenan per total weight of the outer layer;
1.06% by weight of gellan gum per total weight of the outer layer;
1.49% by weight of VITACEL® Wheat Fiber WF 200 from J. Rettenmaier & Söhne (JRS) per total weight of the outer layer;
2.54% by weight of tricalciumphosphat per total weight of the outer layer;
5.3% by weight of rice starch per total weight of the outer layer;
1.48% by weight of soy protein per total weight of the outer layer;
0.42% by weight of vegan lactic acid per total weight of the outer layer;
0.5% by weight of salt per total weight of the outer layer;
0.8% by weight of flavouring agent per total weight of the outer layer.
   This first mixture was heated to a temperature of 93° C. after its preparation and was thereafter deposited from the depositor in the deposition step.

The inner core was prepared from a second mixture comprising:
57.78% by weight of water per total weight of the inner core;
22.8% by weight of soy protein per total weight of the inner core;
0.49% by weight of agar agar per total weight of the inner core;
10.83% by weight of the vegan fibre Promitor® from Tate and Lyle per total weight of the inner core;
0.49% by weight of carrageenan per total weight of the inner core;
1.29% by weight of flavouring agent per total weight of the inner core;
9.85% by weight of sunflower oil per total weight of the inner core;
0.08% by weight of beta-carotene per total weight of the inner core;
0.89% by weight of vegan lactic acid per total weight of the inner core.
   This second mixture was heated to a temperature of 86° C. after its preparation and was thereafter deposited from the depositor in the deposition step.

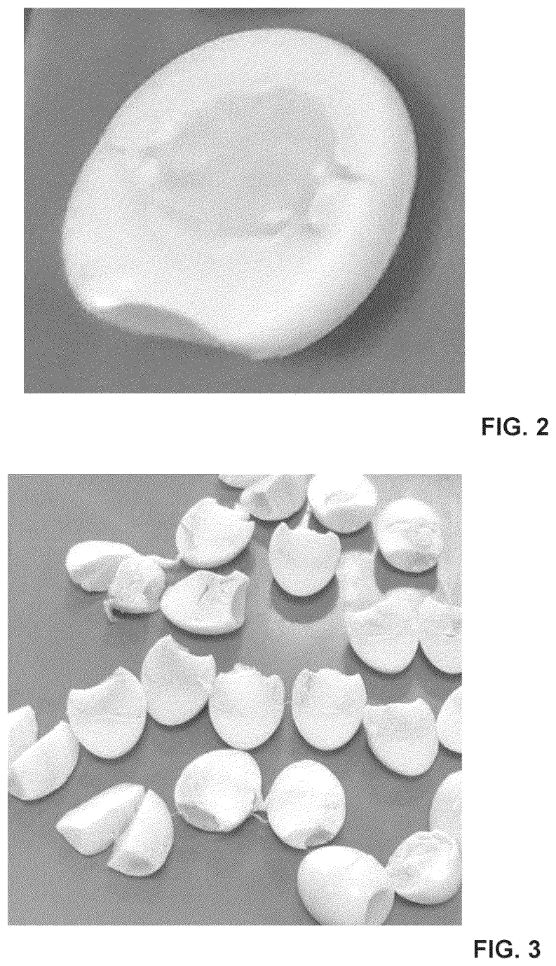

FIGS. 2 to 6 depict examples of a vegan hard-boiled egg comprising a composition and/or method parameters that resulted in products of inferior quality.

In fact, the vegan hard-boiled egg depicted in FIG. 2 comprises an inner core or vegan yolk-like mass that is liquid and shiny and which does not set. Said inner core was prepared without a vegan fibre according to the invention.

The outer layer was prepared from a first mixture comprising:
90.1% by weight of water per total weight of the outer layer;
1.8% by weight of carrageenan per total weight of the outer layer;
0.11% by weight of agar per total weight of the outer layer;
0.38% by weight of VITACEL® Wheat Fiber WF 200 from J. Rettenmaier & Söhne (JRS) per total weight of the outer layer;
2.25% by weight of tricalciumphosphat per total weight of the outer layer;
5.4% by weight of rice starch per total weight of the outer layer.
   This first mixture was heated to a temperature of 91° C. after its preparation and was thereafter deposited from the depositor in the deposition step.

The inner core was prepared from a second mixture comprising:
51.8% by weight of water per total weight of the inner core;
20.73% by weight of chickpea flour per total weight of the inner core;
10.36% by weight of soy protein per total weight of the inner core;
1.04% by weight of agar agar per total weight of the inner core;
0.52% by weight of the emulsifier Palsgaard® DMG 0090 Powder per total weight of the inner core;
15.5% by weight of sunflower oil per total weight of the inner core;
beta-carotene.
   This second mixture was heated to a temperature of 75° C. after its preparation and was thereafter deposited from the depositor in the deposition step.

The vegan hard-boiled eggs depicted in FIG. 3 have an outer layer or vegan albumin-like mass as well as an inner core or vegan yolk-like mass that are too liquid. In particular, the first mixture from which the outer layer was generated was heated to a temperature being too low. Furthermore, the composition did not comprise enough solids, here enough vegan proteins.

The outer layer was prepared from a first mixture comprising:
88.6% by weight of water per total weight of the outer layer;
1.8% by weight of carrageenan per total weight of the outer layer;
0.11% by weight of agar per total weight of the outer layer;
1.4% by weight of VITACEL® Wheat Fiber WF 200 from J. Rettenmaier & Söhne (JRS) per total weight of the outer layer;
2.25% by weight of tricalciumphosphat per total weight of the outer layer;
5.4% by weight of rice starch per total weight of the outer layer;
0.2% by weight of salt per total weight of the outer layer.
   This first mixture was heated to a temperature of 80° C. after its preparation and was thereafter deposited from the depositor in the deposition step.

The inner core was prepared from a second mixture comprising:
61.8% by weight of water per total weight of the inner core;
15% by weight of soy protein per total weight of the inner core;
10% by weight of the vegan fibre Promitor® from Tate and Lyle per total weight of the inner core;
0.5% by weight of carrageenan per total weight of the inner core;
0.2% by weight of flavouring agent per total weight of the inner core;
12.5% by weight of sunflower oil per total weight of the inner core;
beta-carotene.
   This second mixture was heated to a temperature of 75° C. after its preparation and was thereafter deposited from the depositor in the deposition step.

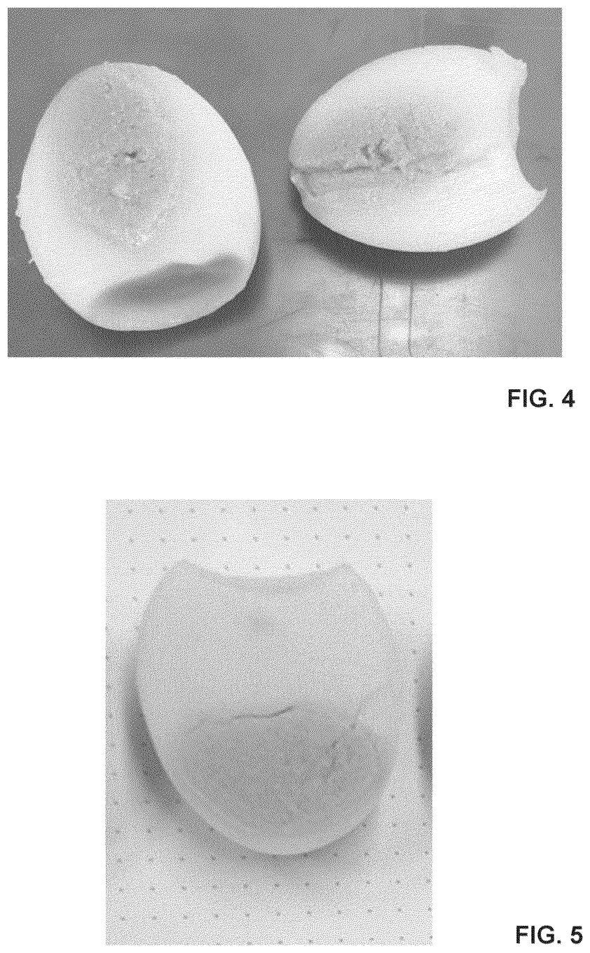

FIG. 4 depicts vegan hard-boiled eggs wherein the first and second mixtures were deposited simultaneously in the deposition step. That is, a starting phase during which only the first mixture is deposited was omitted. As a consequence, the inner core or vegan yolk-like mass is not located essentially centrally within the outer layer.

The outer layer was prepared from a first mixture comprising:
90.1% by weight of water per total weight of the outer layer;
1.8% by weight of carrageenan per total weight of the outer layer;
0.11% by weight of agar per total weight of the outer layer;
1.4% by weight of VITACEL® Wheat Fiber WF 200 from J. Rettenmaier & Söhne (JRS) per total weight of the outer layer;
2.25% by weight of tricalciumphosphat per total weight of the outer layer;
4% by weight of rice starch per total weight of the outer layer;
0.2% by weight of salt per total weight of the outer layer.
   This first mixture was heated to a temperature of 91° C. after its preparation and was thereafter deposited from the depositor in the deposition step.

The inner core was prepared from a second mixture comprising:
56.8% by weight of water per total weight of the inner core;
23% by weight of soy protein per total weight of the inner core;
0.5% by weight of agar agar per total weight of the inner core;
10% by weight of the vegan fibre Promitor® from Tate and Lyle per total weight of the inner core;
0.5% by weight of carrageenan per total weight of the inner core;
0.2% by weight of flavouring agent per total weight of the inner core;
9% by weight of sunflower oil per total weight of the inner core;
beta-carotene.
   This second mixture was heated to a temperature of 80° C. after its preparation and was thereafter deposited from the depositor in the deposition step.

FIG. 5 depicts a vegan hard-boiled egg wherein a difference in the kinematic viscosities of the first mixture and second mixture in the deposition step was too large. In fact, the first mixture was too thin and comprised too much water. The addition of a gelling agent such as gellan gum solved this problem, see FIG. 1.

The outer layer was prepared from a first mixture comprising:
84.6% by weight of water per total weight of the outer layer;
2.7% by weight of carrageenan per total weight of the outer layer;
0.2% by weight of agar per total weight of the outer layer;
1.5% by weight of VITACEL® Wheat Fiber WF 200 from J. Rettenmaier & Söhne (JRS) per total weight of the outer layer;
2.6% by weight of tricalciumphosphat per total weight of the outer layer;
5.4% by weight of rice starch per total weight of the outer layer;
1.4% by weight of soy protein per total weight of the outer layer;
0.3% by weight of vegan lactic acid per total weight of the outer layer;
0.1% by weight of salt per total weight of the outer layer.
   This first mixture was heated to a temperature of 91° C. after its preparation and was thereafter deposited from the depositor in the deposition step.

The inner core was prepared from a second mixture comprising:
53.9% by weight of water per total weight of the inner core;
22.9% by weight of soy protein per total weight of the inner core;
0.5% by weight of agar agar per total weight of the inner core;
10.9% by weight of the vegan fibre Promitor® from Tate and Lyle per total weight of the inner core;
0.5% by weight of carrageenan per total weight of the inner core;
0.2% by weight of flavouring agent per total weight of the inner core;
9.9% by weight of sunflower oil per total weight of the inner core;
0.05% by weight of beta-carotene per total weight of the inner core;
1.2% by weight of vegan lactic acid per total weight of the inner core.
   This second mixture was heated to a temperature of 80° C. after its preparation and was thereafter deposited from the depositor in the deposition step.

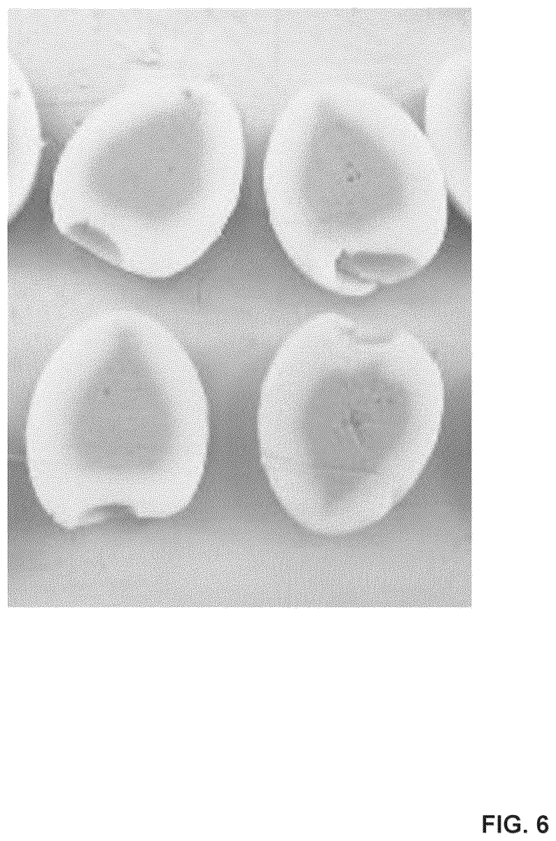

FIG. 6 depicts vegan hard-boiled eggs wherein the inner core or vegan yolk-like mass was too viscous. This resulted from the presence of a vegan protein content in the second mixture being too high.

The outer layer was prepared from a first mixture comprising:
84.82% by weight of water per total weight of the outer layer;
1.59% by weight of carrageenan per total weight of the outer layer;
1.06% by weight of gellan gum per total weight of the outer layer;
1.49% by weight of VITACEL® Wheat Fiber WF 200 from J. Rettenmaier & Söhne (JRS) per total weight of the outer layer;
2.54% by weight of tricalciumphosphat per total weight of the outer layer;
5.3% by weight of rice starch per total weight of the outer layer;
1.48% by weight of soy protein per total weight of the outer layer;
0.42% by weight of vegan lactic acid per total weight of the outer layer;
0.5% by weight of salt per total weight of the outer layer;
0.8% by weight of flavouring agent per total weight of the outer layer.
   This first mixture was heated to a temperature of 93° C. after its preparation and was thereafter deposited from the depositor in the deposition step.

The inner core was prepared from a second mixture comprising:
57.78% by weight of water per total weight of the inner core;
28% by weight of soy protein per total weight of the inner core;
0.49% by weight of agar agar per total weight of the inner core;
10.83% by weight of the vegan fibre Promitor® from Tate and Lyle per total weight of the inner core;
0.49% by weight of carrageenan per total weight of the inner core;
1.29% by weight of flavouring agent per total weight of the inner core;
9.85% by weight of sunflower oil per total weight of the inner core;
0.08% by weight of beta-carotene per total weight of the inner core;
0.89% by weight of vegan lactic acid per total weight of the inner core.
   This second mixture was heated to a temperature of 86° C. after its preparation and was thereafter deposited from the depositor in the deposition step.

As mentioned initially, FIGS. 7 to 15 depict photographs of inner cores and outer layers of vegan food products, wherein the inner cores and the outer layers have different compositions.

In fact, FIGS. 7 to 12 depict outer layers comprising different vegan fibres and/or different amounts of the vegan fibres.

These outer layers in each case were prepared from a first mixture comprising the same base recipe:
2.54% by weight of the tricalciumphosphate per total weight of the first mixture;
1.59% by weight of carrageenan per total weight of the first mixture;
0.50% by weight of table salt per total weight of the first mixture;
5.30% by weight of rice starch per total weight of the first mixture;
1.48% by weight of soy protein per total weight of the first mixture;
0.42% by weight of lactic acid per total weight of the first mixture;
1.06% by weight of gellan gum per total weight of the first mixture;
0.80% by weight of one or more sulphur-compounds and/or a mix containing one or more sulphur-compounds per total weight of the first mixture.

The outer layer depicted in FIG. 7 was prepared from a first mixture comprising the base recipe as outlined above as well as 1.3% by weight of the vegan fibre “VITACEL® Oat Fiber HF 100” per total weight of the outer layer, and wherein water constitutes the remainder for 100%, which is here 85% by weight per total weight of the outer layer.

The vegan fibre “VITALCEL® Oat Fiber HF 100” comprises a water-binding capacity of 2.

The texture of this outer layer was determined as soft with slight grittiness. No perception of water leakage in bite was found nor was it overly dry upon chewing. Furthermore, a tearing was brittle, with a defined, textured edge and minimal striation.

The outer layer depicted in FIG. 8 was prepared from a first mixture comprising the base recipe as outlined above as well as 1.47% by weight of a vegan fibre being the citrus fibre “HERBACEL® AQ® Plus Citrus-F” per total weight of the outer layer, and wherein water constitutes the remainder for 100%, which is here 84.83 by weight per total weight of the outer layer.

The vegan fibre “HERBACEL® AQ® Plus Citrus-F” comprises a water-binding capacity of 25 g/g.

The texture of this outer layer was determined soft and smooth. No perception of water leakage in bite was found. Compared to the outer layer depicted in FIG. 7, it was found drier upon chewing. Furthermore, a tear was determined rough and bumpy and with a minimal striation.

The outer layer depicted in FIG. 9 was prepared from a first mixture comprising the base recipe as outlined above as well as 0.5% by weight of a vegan fibre being the citrus fibre “HERBACEL® AQ® Plus Citrus-F” per total weight of the outer layer, and wherein water constitutes the remainder for 100%, which is here 85.80% by weight per total weight of the outer layer.

The vegan fibre “HERBACEL® AQR Plus Citrus-F” comprises a water-binding capacity of 25 g/g.

The texture of this outer layer was again determined firm and smooth. No perception of water leakage in bite was found. In addition, this outer layer was dry upon chewing, with tear being brittle and with defined edges and clear striation.

The outer layer depicted in FIG. 10 was prepared from a first mixture comprising the base recipe as outlined above as well as 2.0% by weight of a vegan fibre being the citrus fibre “HERBACEL® AQ® Plus Citrus-F” per total weight of the outer layer, and wherein water constitutes the remainder for 100%, which is here 84.30% by weight per total weight of the outer layer.

The vegan fibre “HERBACEL® AQR Plus Citrus-F” comprises a water-binding capacity of 25 g/g.

The texture of this outer layer was determined extremely firm and slightly sandy. No perception of water leakage in bite was found but a slight perception of powder upon tongue. The tear was rough and bumpy.

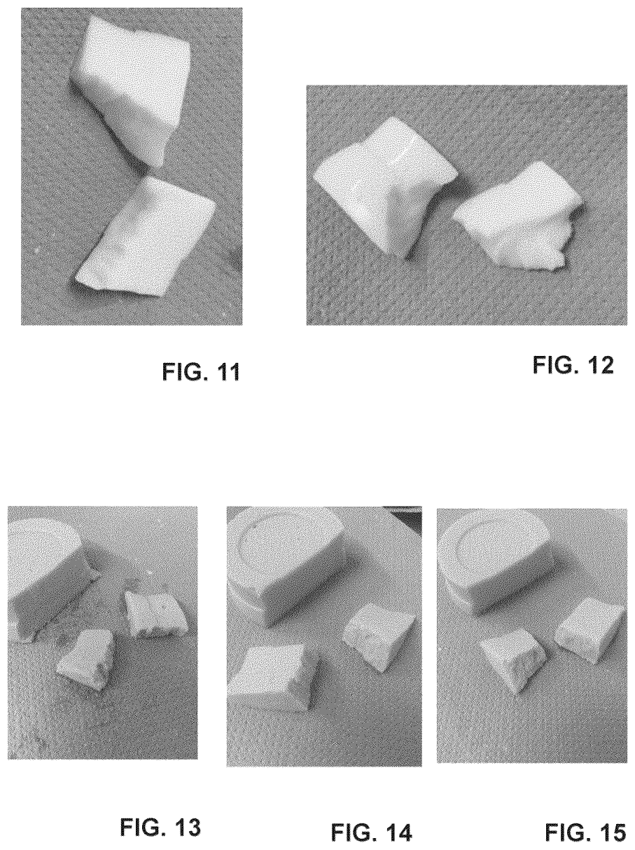

The outer layer depicted in FIG. 11 was prepared from a first mixture comprising the base recipe as outlined above as well as 1.49% by weight of the vegan fibre “VITACEL® Oat Fibre 200” per total weight of the outer layer, and wherein water constitutes the remainder for 100%, which is here 84.81% by weight per total weight of the outer layer.

The vegan fibre “ VITACEL® Oat Fibre 200” comprises a water-binding capacity of 6.8 g/g.

The texture of this outer layer was firm and soft. No perception of water leakage in bite was found. The tear was brittle and defined.

The outer layer depicted in FIG. 12 was prepared from a first mixture comprising the base recipe as outlined above as well as 1.49% by weight of the vegan fibre “VITACEL® Rice Fibre 310” per total weight of the outer layer, and wherein water constitutes the remainder for 100%, which is here 84.81% by weight per total weight of the outer layer.

The vegan fibre “ VITACEL® Rice Fibre 310” comprises a water-binding capacity of 3.8 g/g.

The texture of this outer layer was soft and smooth. No perception of water leakage in bite was found. The tear was brittle and with clear striations. FIGS. 13 to 15 depict inner cores comprising different vegan fibres and/or different amounts of the vegan fibres.

These inner cores in each case were prepared from a second mixture comprising the same base recipe:
0.49% by weight of carrageenan per total weight of the second mixture;
22.80% by weight of the soy protein per total weight of the second mixture;
0.49% by weight of agar agar per total weight of the second mixture;
0.08% by weight of beta-carotene per total weight of the second mixture;
9.85% by weight of sunflower oil per total weight of the second mixture;
0.89% by weight of lactic acid per total weight of the second mixture;
0.50% by weight of table salt per total weight of the second mixture;
1.29% by weight of one or more sulphur-compounds and/or a mix containing one or more sulphur-compounds per total weight of the second mixture.

The inner core depicted in FIG. 13 was prepared from a second mixture comprising the base recipe as outlined above as well as 6.0% by weight of the vegan fibre “VITACEL® Rice Fibre 310” per total weight of the inner core, and wherein water constitutes the remainder for 100%, which is here 57.61% by weight per total weight of the inner core.

The vegan fibre “ VITACEL® Rice Fibre 310” comprises a water-binding capacity of 3.8 g/g.

The texture of this inner core was very firm with slight graininess. No water or oil seepage was determined. The breakage was rough and textured.

The inner core depicted in FIG. 14 was prepared from a second mixture comprising the base recipe as outlined above as well as 4.0% by weight of the vegan fibre “VITACEL® Rice Fibre 310” per total weight of the inner core, and wherein water constitutes the remainder for 100%, which is here 59.61% by weight per total weight of the inner core.

The vegan fibre “ VITACEL® Rice Fibre 310” comprises a water-binding capacity of 3.8 g/g.

The texture of this inner core was firm and smooth. No water or oil seepage was determined. The breakage was rough and textured.

The inner core depicted in FIG. 15 was prepared from a second mixture comprising the base recipe as outlined above as well as 2.0% by weight of the vegan fibre “VITACEL® Rice Fibre 310” per total weight of the inner core, and wherein water constitutes the remainder for 100%, which is here 61.61% by weight per total weight of the inner core.

The vegan fibre “ VITACEL® Rice Fibre 310” comprises a water-binding capacity of 3.8 g/g.

The texture was soft and smooth. No water or oil seepage was found. The breakage was rough and textured.

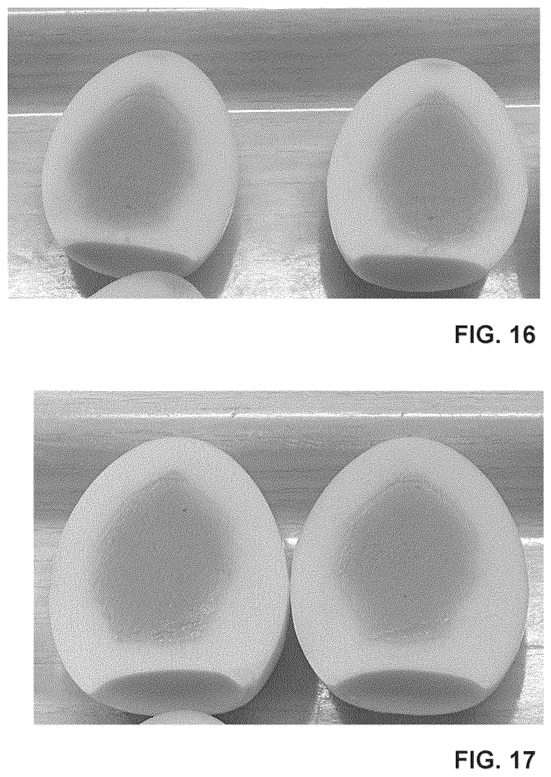

FIGS. 16 and 17 depict further vegan hard-boiled eggs whose inner core and outer layer comprise compositions according to the invention and that have been prepared according to the method of the invention.

That is, in FIG. 16 the outer layer was prepared from a first mixture comprising:
85.91% by weight of water per total weight of the outer layer;
1.59% by weight of carrageenan per total weight of the outer layer;
1.06% by weight of gellan gum per total weight of the outer layer;
1.0% by weight of KaroPRO 1-26 per total weight of the outer layer;
2.54% by weight of tricalciumphosphat per total weight of the outer layer;
5.3% by weight of rice starch per total weight of the outer layer;
1.48% by weight of soy protein per total weight of the outer layer;
0.42% by weight of vegan lactic acid per total weight of the outer layer;
0.5% by weight of salt per total weight of the outer layer;
0.2% by weight of flavouring agent per total weight of the outer layer.
   This first mixture was heated to a temperature of 115° C. after its preparation and was thereafter deposited from the depositor in the deposition step.

The inner core was prepared from a second mixture comprising:
64.65% by weight of water per total weight of the inner core;
22.8% by weight of soy protein per total weight of the inner core;
0.5% by weight of agar agar per total weight of the inner core;
0.8% by weight of the vegan fibre KaroPRO 1-26 per total weight of the inner core;
0.5% by weight of carrageenan per total weight of the inner core;
9.85% by weight of rapeseed oil per total weight of the inner core;
0.5% by weight of salt per total weight of the inner core;
0.4% by weight of beta-carotene per total weight of the inner core.
   This second mixture was heated to a temperature of 110° C. after its preparation and was thereafter deposited from the depositor in the deposition step.

The vegan fibre KaroPRO 1-26 has a water-binding capacity of 26.

In FIG. 17, the outer layer was prepared from a first mixture comprising:
85.61% by weight of water per total weight of the outer layer;
1.59% by weight of carrageenan per total weight of the outer layer;
1.06% by weight of gellan gum per total weight of the outer layer;
1.3% by weight of VITACEL® Rice Fiber 310 from J. Rettenmaier & Söhne (JRS) per total weight of the outer layer;
2.54% by weight of tricalciumphosphat per total weight of the outer layer;
5.3% by weight of rice starch per total weight of the outer layer;
1.48% by weight of soy protein per total weight of the outer layer;
0.42% by weight of vegan lactic acid per total weight of the outer layer;
0.5% by weight of salt per total weight of the outer layer;
0.8% by weight of flavouring agent per total weight of the outer layer.
   This first mixture was heated to a temperature of 115° C. after its preparation and was thereafter deposited from the depositor in the deposition step.

The inner core was prepared from a second mixture comprising:
63.45% by weight of water per total weight of the inner core;
22.8% by weight of soy protein per total weight of the inner core;
0.5% by weight of agar agar per total weight of the inner core;
2% by weight of the vegan fibre VITACEL® Rice Fiber 310 per total weight of the inner core;
0.5% by weight of carrageenan per total weight of the inner core;
9.85% by weight of rapeseed oil per total weight of the inner core;
0.5% by weight of salt per total weight of the inner core;
0.4% by weight of beta-carotene per total weight of the inner core.
   This second mixture was heated to a temperature of 110° C. after its preparation and was thereafter deposited from the depositor in the deposition step.

The vegan fibre VITACEL® Rice Fiber 310 has a water-binding capacity of 3.8.

As becomes readily apparent from FIGS. 16 and 17, said vegan hard-boiled eggs perfectly mimic a hard-boiled egg of a real chicken as well.

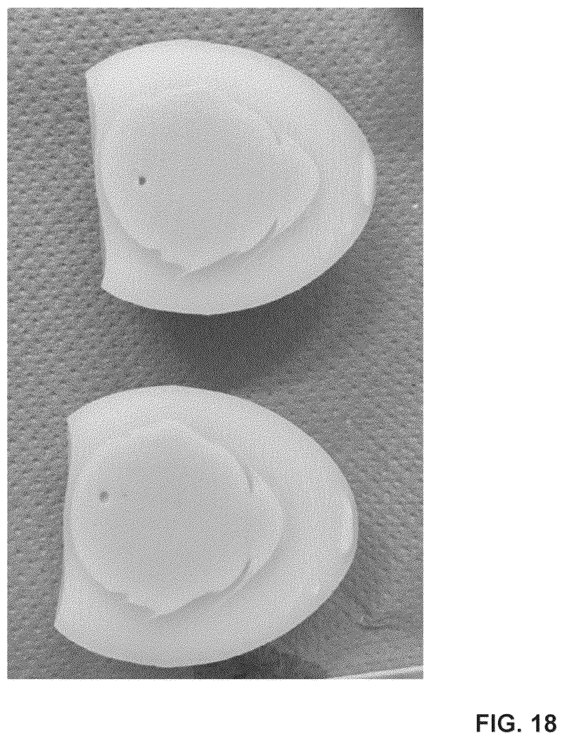

FIG. 18 depicts another vegan hard-boiled egg in the form of a picnic egg whose inner core and outer layer comprise another composition according to the invention, wherein less compounds were used as compared to the previously discussed compositions.

That is, the outer layer was prepared from a first mixture comprising the following compounds:
88.9% by weight of water per total weight of the first mixture;
7% by weight of rise starch REMY ODR-6 BIO per total weight of the first mixture;
1.4% by weight of carrageen Ceamblom WD 91-539 per total weight of the first mixture;
1.8% by weight of the wheat fibre VITACEL® Wheat Fiber WF 200 per total weight of the first mixture; and
0.9% by weight of gellan gum Kelcogel® F per total weight of the first mixture.

The VITACEL® Wheat Fiber WF 200 has a water-binding capacity of 8.6 g/g.

The inner core was prepared from a second mixture comprising the following compounds:
64.87% by weight of water per total weight of the second mixture;
24% by weight of soy protein Supro XT 219D IP per total weight of the second mixture;
10.13% by weight of Promitor® SGF 70R per total weight of the second mixture; and
1% by weight of carrageen Ceambloom WD 91-539 per total weight of the second mixture.

The vegan fibre “PROMITOR® SGF 70R” fibre is water-soluble and thus comprises a water-binding capacity of 0 g/g.

The inner core and the outer layer have been prepared according to the method of the invention. As becomes readily apparent from FIG. 18, said vegan hard-boiled egg again perfectly mimics a hard-boiled egg of a real chicken.

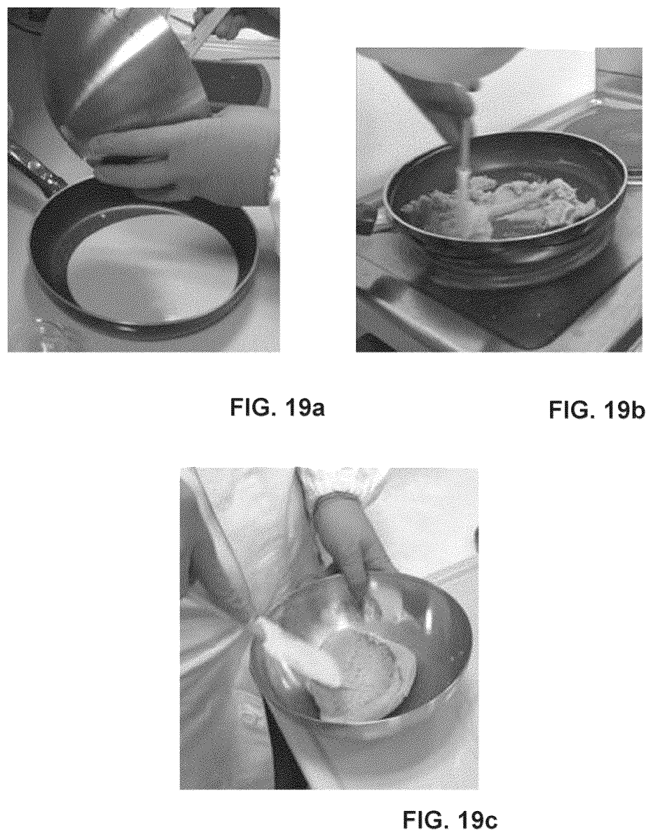

FIGS. 19a to 19c depict different stages of an inner core having a composition according to the state of the art that is prepared according to the method of the invention. That is, said inner core corresponds to a yolk-like phase as disclosed in example 1 and with the colouring agent of tomato sauce as disclosed in example 2 of WO 2019/038794 A:
40 gram lupin flour;
7.6 gram agar;
54.2 gram water;
57.2 gram oil-in-water emulsion;
40 gram tomato sauce;
2 gram kala-namak salt.

The oil-in-water emulsion comprises the following components:
20 gram powdered rice drink ;
2.5 gram monoglyceride;
32 gram water; and
25 gram sunflower oil.

Although not depicted an outer layer corresponding to an albumen-like phase as disclosed in example 1 of WO 2019/038794 A has been prepared as well, wherein the albumen-like phase comprised:
11.5 gram calcium carbonate;
451 gram water;
13.5 gram agar;
24 gram powdered rice drink.

During the preparation of the yolk-like phase or the inner core, respectively, the components of the oil-in-water emulsion were mixed and emulsified in a first step. Then all of the yolk-like phase or inner core components were mixed aside from the kala-namak salt. Thereafter, the yolk-like phase or inner core mixture was heated in a pan until it reached 70° C. Thereafter, the pan was removed and kala namak salt was stirred in.

As readily becomes evident from FIGS. 19a to 19c, as soon as the components of said yolk-like phase or inner core are heated slightly, a solid mass is formed. In particular, at 70° C. the mass is of such firmness that it is impossible to deposit it from the depositor in a deposition step as required by the method according to the invention.

Instead, and as disclosed in WO 2019/038794 A, the albumen-like phase and the yolk-like phase need to be produced separately and thereafter be combined to the final product. This is in clear contrast to the present invention, wherein the presence of the vegan fibre allows the production of the vegan food product by depositing the first and second mixtures from a depositor.

Moreover, the vegan egg of WO 2019/038794 A has shown to be more dough-like, being sticky and more like playdough, stretching elastically when being pulled apart, and not breaking with textured edges that are rough. Furthermore, the albumen-like phase has shown to leak water upon biting into it, providing a watery texture. Moreover, the albumen-like phase and the yolk-like phase dry out quicker when exposed to air upon cutting open, i.e. a dried crust forms already after 2 hours after being cut open versus 6 hours with the vegan food product according to the invention, wherein the vegan fibres, inter alia, reduce a loss of water.

1.-15. (canceled)

16. A vegan food product comprising:
at least one outer layer, and
at least one inner core,
wherein the inner core is surrounded by the outer layer,
wherein the inner core comprises at least one vegan fibre and in that the outer layer comprises at least one vegan fibre,
wherein the vegan fibre of the inner core comprises a water-binding capacity of 40 g/g or less or of 30 g/g or less or of 20 g/g or less or of 15 g/g or less, and
wherein the vegan fibre of the outer layer comprises a water-binding capacity of 40 g/g or less or of 30 g/g or less or of 25 g/g or less.

17. The vegan food product according to claim 16, wherein at least one of:
i. the vegan fibre of the inner core comprises a water-binding capacity in the range of 0 g/g to 15 g/g,
ii. the vegan fibre of the outer layer comprises a water-binding capacity in the range of 2 g/g to 25 g/g,
iii. the vegan fibre of the inner core comprises a water activity in the range of 2% to 10% or in the range of 3% to 8%, or
iv. the vegan fibre of the outer layer comprises a water activity in the range of 2% to 10% or in the range of 3% to 8%.

18. The vegan food product according to claim 16, wherein at least one of:
i. at least one of: the vegan fibre of the inner core is water-soluble, water-insoluble, a maize fibre, a citrus fruit peel fibre, an oat fibre, a pea fibre, a chickpea fibre, a wheat fibre, a potato fibre, a rice fibre or soy fibre, or
ii. at least one of: the vegan fibre of the outer layer is water-insoluble, water soluble, a wheat fibre, a rice fibre, an oat fibre, a potato fibre, a pea fibre, a teff fibre or a citrus fruit peel fibre.

19. The vegan food product according to claim 16, wherein at least one of:
i. the inner core comprises between 1% by weight to 20% by weight of the vegan fibre per total weight of the inner core, or
ii. the outer layer comprises between 0.1% by weight to 6% by weight of the vegan fibre per total weight of the outer layer.

20. The vegan food product according to claim 16, wherein at least one of:
i. a length of the vegan fibre of the inner core is in the range of 80 micrometer to 400 micrometer, or
ii. a length of the vegan fibre of the outer layer is in the range of 80 micrometer to 400 micrometer.

21. The vegan food product according to claim 16, wherein the inner core furthermore comprises at least one of:
one or more gelling agents;
at least one of: i) at least one vegan protein or ii) at least one source of vegan protein;
at least one colouring agent;
water;
at least one source of fat;
at least one preserving agent,
at least one salt; or
at least one flavouring agent.

22. The vegan food product according to claim 16, wherein the outer layer furthermore comprises at least one of:
one or more colouring agents;
one or more gelling agents;
at least one salt;
at least one plant-based starch;
at least one of: a) at least one vegan protein or b) at least one source of vegan protein;
water;
at least one preserving agent; or
at least one flavouring agent.

23. A method of producing a vegan food product comprising the steps of:
providing at least one outer layer from a first mixture, and
providing at least one inner core from a second mixture,
wherein the inner core is surrounded by the outer layer,
wherein the inner core comprises at least one vegan fibre and in that the outer layer comprises at least one vegan fibre,
wherein the vegan fibre of the inner core comprises a water-binding capacity of 40 g/g or less or of 30 g/g or less or of 20 g/g or less or of 15 g/g or less, and
wherein the vegan fibre of the outer layer comprises a water-binding capacity of 40 g/g or less or of 30 g/g or less or of 25 g/g or less.

24. The method according to claim 23, wherein the first mixture and the second mixture are deposited in at least one deposition step, such, that the inner core is surrounded by the outer layer.

25. The method according to claim 23, wherein the first mixture is associated with a first kinematic viscosity and the second mixture is associated with a second kinematic viscosity at least in the deposition step, and wherein at least one of:
i. a difference between the first kinematic viscosity and the second kinematic viscosity at least in the deposition step is 40′000 cSt or less or 20′000 cSt or less or 2′000 cSt or more, or 5′000 cSt or more,
ii. the first kinematic viscosity at least in the deposition step is in the range of 20′000 cSt to 40′000 cST or in the range of 25′000 cST to 35′000 cST, or
iii. the second kinematic viscosity at least in the deposition step is in the range of 5′000 cST to 25′000 cST or in the range of 9′000 cST to 15′000 cST.

26. The method according to claim 23, wherein at least one of:
i. at least one of the first mixture or the second mixture is prepared at room temperature, or
ii. the first mixture is heated after its preparation, or
iii. the second mixture is heated after its preparation.

27. The method according to claim 23, wherein the first mixture and the second mixture are deposited in the deposition step from a depositor comprising a first deposition nozzle for depositing the first mixture and a second deposition nozzle for depositing the second mixture.

28. The method according to claim 23, wherein the first mixture and the second mixture are at least temporarily deposited simultaneously in the deposition step.

29. The method according to claim 23, wherein at least one of:
i. at least one of: i) the first mixture is deposited in the deposition step at a temperature in the range of 76° C. to 93° C. or ii) the second mixture is deposited in the deposition step at a temperature in the range of 100° C. to 115° C., or
ii. the first mixture and the second mixture are deposited in the deposition step into one or more moulds.

30. A method of producing a vegan food product comprising using a vegan fibre wherein the vegan fibre comprises a water-binding capacity of 40 g/g or less or of 30 g/g or less or of 25 g/g or less.

31. The vegan food product according to claim 16, wherein the vegan food product is a vegan hard-boiled egg.

32. The vegan food product according to claim 21, wherein at least one of:
the gelling agent is at least one of: a polysaccharide or an algae-based gelling agent;
at least one of a) the vegan protein is at least one of: a soy protein, a potato protein, a wheat protein, a pea protein, a rice protein, a chickpea protein, a fababean protein, a mungbean protein, a pumpkin seed protein, a lupin protein, or b) the source of vegan protein is algae;
the colouring agent is at least one of: a natural colorant, beta-carotene, or turmeric;
the source of fat is at least one of: a vegetable oil, sunflower oil, coconut oil, or rapeseed oil;
the preserving agent is an acid;
the salt is table salt; or
the flavouring agent is at least one of: comprising one or more sulphur-compounds, a natural salt, or kala namak.

33. The vegan food product according to claim 32, wherein at least one of:
at least one of: a) the polysaccharide is guar gum or b) the algae-based gelling agents are at least one of: carrageenan, agar agar, xanthan or alginate; or
the acid being at least one of: a) lactic acid of non-animal origin or b) citric acid.

34. The vegan food product according to claim 22, wherein at least one of:
the colouring agent is at least one of: a calcium salt, a phosphate-compound, a carbonate-compound, a metal oxide-compound,
the gelling agent is at least one of: a) a polysaccharide or b) an algae-based gelling agent;
the salt is table salt;
the plant-based starch is based on at least one of: rice, potato, maize, wheat or tapioca;
at least one of a) the vegan protein is at least one of: a soy protein, a potato protein, a wheat protein, a pea protein, a rice protein, a chickpea protein, a fababean protein, a mungbean protein, a pumpkin seed protein, or a lupin protein, or b) the source of vegan protein is algae;
the preserving agent is an acid; or
the flavouring agent is at least one of: comprising one or more sulphur-compounds, a mix containing one or more sulphur-compounds, a natural salt, or kala namak.

35. The vegan food product according to claim 34, wherein at least one of:
the colouring agent is at least one of: tricalciumphosphate, calcium carbonate or titanium dioxide;
at least one of a) the polysaccharide is at least one of: guar gum, or gellan gum, or b) the algae-based gelling agents are at least one of: carrageenan, agar agar, xanthan or alginate; or
the acid is at least one of: lactic acid of non-animal origin, citric acid or phosphoric acid.

36. The method according to claim 23, wherein the vegan food product is a vegan hard-boiled egg.

37. The method according to claim 24, wherein the first mixture and the second mixture are deposited in one deposition step.

38. The method according claim 26, wherein at least one of:
the first mixture is heated after its preparation to a temperature in the range of 100° C. to 120° C., or
the second mixture is heated after its preparation to a temperature in the range of 100° C. to 120° C.

39. The method according to claim 27, wherein the first deposition nozzle and the second deposition nozzle are arranged concentrically with respect to one another.
